(19) United States
(12) Patent Application Publication
(10) Pub. No.: US 2016/0147934 A1
(43) Pub. Date: May 26, 2016

(54) DETERMINATION OF ELECTRONIC CIRCUIT ROBUSTNESS

(71) Applicant: CALIFORNIA INSTITUTE OF TECHNOLOGY, Pasadena, CA (US)

(72) Inventors: Sean Keller, Bellevue, WA (US); Alain Martin, Pasadena, CA (US)

(73) Assignee: California Institute of Technology, Pasadena, CA (US)

(21) Appl. No.: 14/899,829

(22) PCT Filed: Apr. 22, 2014
(86) PCT No.: PCT/US14/35020

§ 371 Date: Dec. 18, 2015

Related U.S. Application Data
(60) Provisional application No. 61/838,037, filed on Jun. 21, 2013.

(51) Int. Cl. G06F 17/50

(52) U.S. Cl. CPC G06F 17/5081

(57) ABSTRACT

Technologies are generally described that relate to analysis of circuits and that facilitate determination of electronic circuit robustness. An example method includes performing, for a cell device by a unit including a processor, statistical analysis to obtain statistical information for the cell device that is indicative of a robustness of the cell device. The robustness of the cell device pertains to a parameter variation of the cell device that is related to a noise of the cell device. The method also includes determining a characteristic of the cell device based on the statistical information.

### CROSS-REFERENCE TO RELATED APPLICATION

The present application is related to and claims the benefit of the earliest available effective filing date from the following listed application: U.S. Provisional Patent Application No. 61/838,037, titled “Method for Quantifying Electronic Circuit Robustness,” naming Sean J. Keller and Alain J. Martin as inventors, filed Jun. 21, 2013, which is currently co-pending.

All subject matter of the listed application is incorporated herein by reference to the extent such subject matter is not inconsistent herewith.

### TECHNICAL FIELD

The subject disclosure relates generally but not exclusively to determination of electronic circuit robustness.

### BACKGROUND

Unless otherwise indicated herein, the materials described in this section are not prior art to the claims in this application and are not admitted to be prior art by inclusion of this section.

Design of efficient and robust modern binary digital systems can be an arduous task. The use of numerous levels of logical abstraction may be typically employed due to the sheer complexity of utilizing upwards of a billion, for example, devices in modern binary digital systems. Errors introduced at different levels of abstraction can result in circuits that fail to function as expected for a number of reasons (e.g., timing, logical, functional, and/or other types of failures). Understanding and quantifying these different modes of failure can be useful, but failures in the base digital assumption can supersede all other failures. If a gate cannot switch between logic values, then the gate may not be able to perform computation, for example.

With regard to static direct current (DC) analysis, logic gates in modern technologies may exhibit a number of frequency-dependent effects. Incorporating these effects can greatly increase the complexity of analysis.

### SUMMARY

In various, non-limiting embodiments, systems, devices, and/or computer-readable storage media that facilitate determination of electronic circuit robustness are described herein.

In some embodiments, methods include performing, for a cell device by a unit including a processor, statistical analysis to obtain statistical information for the cell device. The statistical information can be indicative of robustness of the cell device. In these embodiments, the robustness of the cell device pertains to a parameter variation of the cell device that is related to a noise of the cell device. The methods can also include determining a characteristic of the cell device based on the statistical information.

In other embodiments, other methods are described. For example, methods can include determining, by a unit including a processor, characteristics that pertain to respective cell devices associated with circuit diagram information. The characteristics can include functions of respective robustness data for the cell devices. In these embodiments, the methods can also include determining a quantification of reliability for the circuit diagram information based on composing respective characteristics for the cell devices of the circuit diagram information.

In other embodiments, yet other methods are described. For example, methods can include determining, by a unit including a processor, characteristics that pertain to candidate cell devices that are candidates for association with a circuit. The characteristics can include functions of respective robustness data for the candidate cell devices. The respective robustness data can be associated with parameter variations of the candidate cell devices that are related to noises of the plurality of candidate cell devices. In these embodiments, the methods can also include selecting one or more cell devices of the candidate cell devices based on the determined characteristics for the candidate cell devices.

In some embodiments, devices are described. For example, some devices can include a first component configured to perform statistical analysis for a cell device to determine a robustness of the cell device. The robustness of the cell device can be associated with a parameter variation of the cell device that is related to a noise of the cell device. The devices can also include a second component coupled to the first component and configured to generate statistical information for the cell device based on the statistical analysis. The statistical information can be indicative of the robustness of the cell device. The devices can also include a third component coupled to the second component and configured to determine a characteristic of the cell device based on the statistical information.

In some embodiments, non-transitory computer-readable storage media are described. For example, non-transitory computer-readable storage media having computer-executable instructions stored thereon that, in response to execution by a processor, cause a device to perform operations are described. The operations can include determining characteristics that pertain to respective cell devices associated with circuit diagram information. The characteristics can include functions of respective robustness data for the cell devices. The respective robustness data can be based on parameter variations of the respective cell devices and noises of the respective cell devices. The operations can also include determining a quantification of reliability for the circuit diagram information based on composing the respective characteristics for the cell devices of the circuit diagram information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, various non-limiting embodiments are further described with reference to the accompanying drawings in which:

FIG. 1 illustrates an example block diagram of a system configured to facilitate determination of electronic circuit robustness in accordance with one or more embodiments described herein;

FIG. 2 illustrates an example block diagram of cell device information stored within a cell device data store and employed by the system of FIG. 1 to facilitate determination of electronic circuit robustness in accordance with one or more embodiments described herein;

FIG. 3 illustrates an example block diagram of circuit diagram information stored within a circuit diagram information data store and employed by the system of FIG. 1 to facilitate determination of electronic circuit robustness in accordance with one or more embodiments described herein;

FIG. 4 illustrates an example block diagram of a device of the system of FIG. 1 and configured to facilitate determination of electronic circuit robustness in accordance with one or more embodiments described herein;

FIG. 5 illustrates an example block diagram of a robustness determination component of the device of FIG. 4 and configured to facilitate determination of electronic circuit robustness in accordance with one or more embodiments described herein;

FIG. 6 illustrates an example block diagram of a circuit design component of the device of FIG. 4 and configured to generate information for circuit design based on determination of electronic circuit robustness in accordance with one or more embodiments described herein;

FIGS. 7-10 illustrate example flowcharts of methods associated with determination of electronic circuit robustness in accordance with one or more embodiments described herein;

FIG. 11 illustrates an example graph of statistical voltage transfer characteristics (VTCs) for 100 Monte Carlo trials of a minimum-size inverter and which may be employed for determination of electronic circuit robustness in accordance with one or more embodiments described herein;

FIG. 12 illustrates an example circuit of a cross-coupled inverter pair and direct circuit noise voltage sources for which electronic circuit robustness can be determined in accordance with one or more embodiments described herein;

FIG. 13 illustrates an example graph of statistical voltage transfer characteristics for a minimum-size inverter and which may be employed for determination of electronic circuit robustness in accordance with one or more embodiments described herein;

FIGS. 14, 15, 16 and 17 illustrate example graphs depicting probability density distributions for input parameters for an inverter at respective values of V_{DD} values, and which may be employed for determination of electronic circuit robustness in accordance with one or more embodiments described herein

FIG. 18 illustrates example graphs of a ratio of input VTC parameter variance to output VTC parameter variance in a complementary metal-oxide semiconductor (CMOS) for determination of electronic circuit robustness in accordance with one or more embodiments described herein;

FIG. 19 illustrates example graphs of correlation between input parameters for determination of electronic circuit robustness in accordance with one or more embodiments described herein;

FIGS. 20, 21, 22, 23 and 24 illustrate example graphs depicting probabilities of minimum-size cross-coupled inverter-pair failure for respective noise margin threshold values for determination of electronic circuit robustness in accordance with one or more embodiments described herein;

FIG. 25 illustrates an example of an infinite chain construct equivalent to the cross-coupled pair of FIG. 12 for determination of electronic circuit robustness in accordance with one or more embodiments described herein;

FIG. 26 illustrates an example of a chain of inverters for determination of electronic circuit robustness in accordance with one or more embodiments described herein;

FIGS. 27, 28, 29, 30, 31 illustrate example graphs depicting probabilities of failure for minimum-size inverters in chains for determination of electronic circuit robustness in accordance with one or more embodiments described herein;

FIG. 32 illustrates an example NAND2 circuit diagram for determination of electronic circuit robustness in accordance with one or more embodiments described herein;

FIGS. 33 and 34 illustrate example graphs of VTCs for the minimum-size NAND2 for determination of electronic circuit robustness in accordance with one or more embodiments described herein;

FIG. 35 illustrates an example circuit diagram of NAND2 inverter equivalence for determination of electronic circuit robustness in accordance with one or more embodiments described herein;

FIG. 36 illustrates an example graph of NAND2 input correlation for determination of electronic circuit robustness in accordance with one or more embodiments described herein;

FIG. 37 illustrates an example circuit diagram detailing equivalent gate pairs formed from multiple fan-in and fan-out gate networks for determination of electronic circuit robustness in accordance with one or more embodiments described herein;

FIGS. 38 and 39 illustrate example graphs depicting probabilities of a chain of 20 alternating NAND2 and NOR2 gates failing for respective noise margin thresholds for determination of electronic circuit robustness in accordance with one or more embodiments described herein;

FIG. 40 illustrates an example graph of maximum number of equivalent gate pairs versus V_{DD} for chains of alternating gates and combinations from a defined set of gates for determination of electronic circuit robustness in accordance with one or more embodiments described herein;

FIG. 41 illustrates an example graph of maximum noise margin threshold versus V_{DD} for chains of alternating gates and combinations from a defined set of gates for determination of electronic circuit robustness in accordance with one or more embodiments described herein;

FIG. 42 illustrates an example block diagram of a computing device that is arranged for quantification of circuit robustness in accordance with one or more embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

Parameter variation can be caused by stochastic process variation and intrinsic parameter fluctuations (IPF). Parameter variation can be a reason why modern digital circuits that function at the process nominal supply voltage (for example, V_{DD}) may eventually fail as the supply is lowered. Further, parameter variation may make functional digital circuits less robust and hence less reliable. This reduction in robustness may be of little consequence at the process nominal supply voltage V_{DD}, but, as V_{DD} is lowered, the reduction in robustness may become a more substantial design concern.

In modern complementary metal oxide semiconductor (CMOS) technologies, device parameters such as channel length, oxide thickness and dopant concentration can have significant deviations from nominal values due to process-induced and/or intrinsic parameter fluctuations. Process variability may be considered a global, predictable, and gradual skew in device characteristics introduced by the complexity of manufacturing chips (e.g., from thermal gradients during fabrication). Intrinsic parameter fluctuations may be truly statistical in nature and may cause significant deviations from device to device within a chip.

Circuit noise (e.g., thermal noise) can result from physical components and/or man-made digital switching components. Possible dominant sources of noise from physical components in modern CMOS, which may have significant impact on radio frequency (RF) CMOS circuits, may include 1/frequency (1/f) noise and thermal noise. Switching noise can be caused by the rapid full-rail voltage swings typical in digital systems, and can include cross-talk due to capacitive and inductive coupling, charge sharing, supply-rail and ground noise, and/or substrate noise.

Increasing parameter variation in circuits can tend to reduce robustness to noise. Intrinsic variations can be attributed to atomistic effects (e.g., random dopant fluctuation (RDF)) and device structure variations (e.g., line edge roughness (LER)). There may be a number of different ways to characterize and partition these effects, and the approach used herein is to consider a global component wherein all devices on a chip may be affected in the same way, and a local component wherein each device on a chip may have a number of statistical parameters drawn from distributions with mean values set by the global skew.

Considering variation in terms of a global component and a local component may simplify statistical analysis while permitting a circuit designer to choose, for example, a worst-case 3σ global corner wherein the die that fall outside of this range are assumed not to yield. The worst case 3σ global corner refers to the instance of global Process Voltage Temperature (PVT) variation at which the functional yield is minimal.

For a circuit's operating subthreshold, the local component of variation can be dominated by RDF and can be accurately modeled by a normally distributed uncorrelated device threshold, Vₜ, variation. Near-threshold, local variation may exhibit some degree of spatial correlation, and at the process nominal supply voltage V_{DD}, spatial correlation can be significant. This increase in the spatial correlation of local variation as a function of V_{DD} can be attributed to the fact that channel-length variation may have little effect on devices' operating subthreshold but may become the dominant effect at approximately twice the threshold voltage. Channel length variation can be spatially correlated between devices within some radius, and can be straightforward to model.

Given that one feature of the embodiments described herein is to quantify the robustness of low-power subthreshold and near-threshold circuits, local parameter variation can be treated as random and uncorrelated; however, the effects of spatial correlation can be included. Furthermore, in some embodiments, SPICE electronic circuit simulations, along with foundry-provided statistically-extracted BSIM4 models, are employed for the embodiments described herein as a basis for correctness; these models are considered accurate over the entire device operating range. Most of the figures make use of the statistical BSIM4 models (the corresponding plotted data are typically referred to as “Actual” within the figures). These models form the base case and are assumed to be representative of actual silicon. As such, these models are referred to as “Actual” in figures throughout.

Briefly stated, technologies are generally described that relate to analysis of circuits and that facilitate determination of electronic circuit robustness. An example method may include performing, for a cell device by a unit including a processor, statistical analysis to obtain statistical information for the cell device that is indicative of a robustness of the cell device. The robustness of the cell device may pertain to a parameter variation of the cell device that is related to a noise of the cell device. The method may also include determining a characteristic of the cell device based on the statistical information. In some embodiments, determining the characteristic may include determining the statistical voltage transfer characteristics (VTC) of the cell device. In various embodiments, the parameter variation of the cell device may include at least one of the channel length variation, the oxide thickness variation or the dopant concentration variation of a component of the cell device, relative to another cell device.

In some embodiments, information indicative of a description of the cell devices from circuit diagram information can be obtained. Circuit diagram information can include information describing the function or components of a circuit for which circuit robustness is to be determined. In response to quantifying the circuit robustness, the yield of the circuit diagram information can be predicted.

In some embodiments, a circuit to be included in a device can be selected based on the prediction of yield and/or quantification of circuit robustness generally. Being able to quantify the robustness of a circuit makes it possible to predict yield and to perform new optimizations (or other customization or tailoring) that include robustness when considering gate choice and transistor sizing during cell design and optimization, circuit design and optimization, and/or place and route.

The embodiments described herein may account for parameter variation and may be therefore suitable for modern low-voltage circuit analysis. Further, noise margin based analysis of memory cells and other devices/circuits may be described using a generalized noise margin target based analysis as opposed to a simple binary failure model (e.g., statistical noise margin (SNM)>0 or SNM<0).

One or more of the embodiments described herein can analyze the robustness of a circuit, or chip, in an efficient and scalable manner with any number of elements (e.g., transistors, etc.). In some examples, the circuits, or chips to which the disclosed embodiments apply may include those having one million to one billion transistors, for example. Further, circuit robustness can be included alongside energy, delay, and area during circuit design and optimization. A computation aspect of the embodiments may be applied to a defined set of cell devices typically included in cell device libraries and memories, and the calculation of robustness cost may be generally linear in the number of instances of these cell devices.

Further, one or more of the embodiments described herein can define a method to calculate robustness in such a way that the robustness can be feasibly computed for large circuits (e.g., billions of gates), and which may also fit in with any suitable method of system design, including standard-cell hierarchical digital circuit design. As such, a new compact model for statistical robustness is described herein with parameters that can be stored alongside timing and energy data in a cell device data store (e.g., cell libraries). Moreover, the model employed by a device to determine robustness can be defined such that the compact data is composable. Compact data may be composable if the robustness of an arbitrary network of standard cells is computable by the composition of robustness data from member cell devices. In this way, the robustness of a large circuit (built out of standard cells) can be readily calculated.

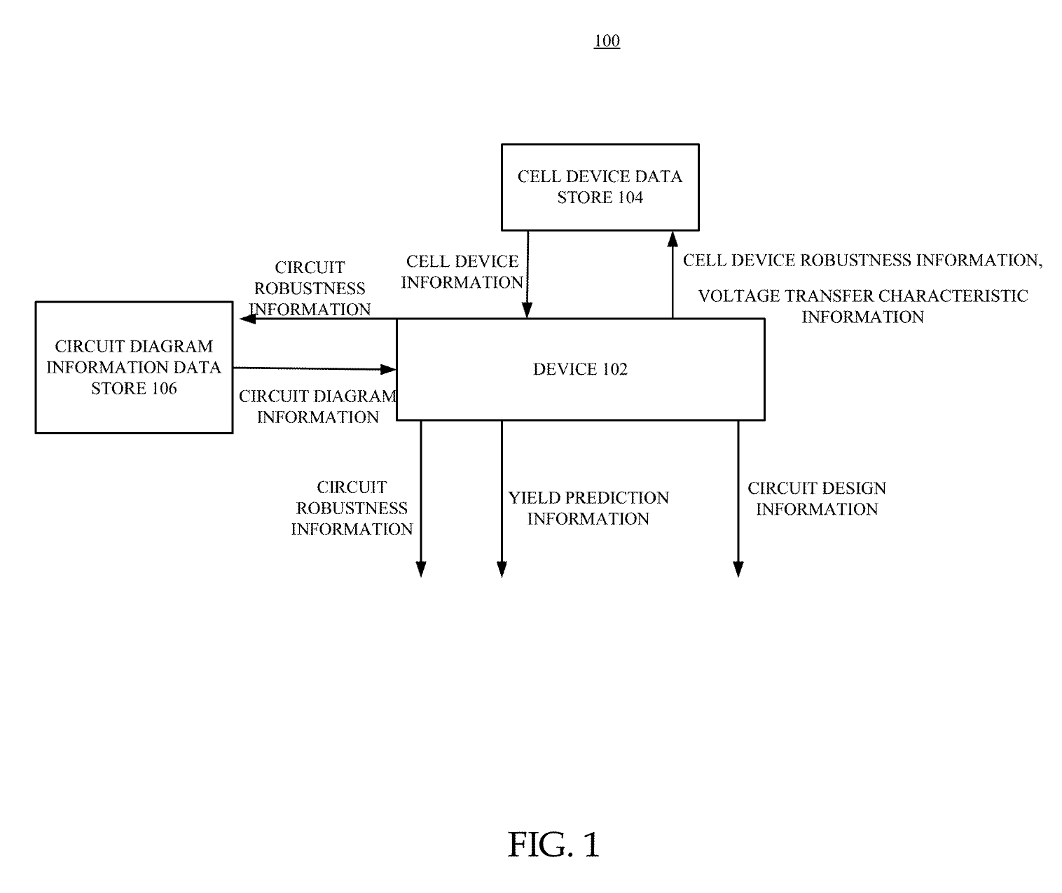

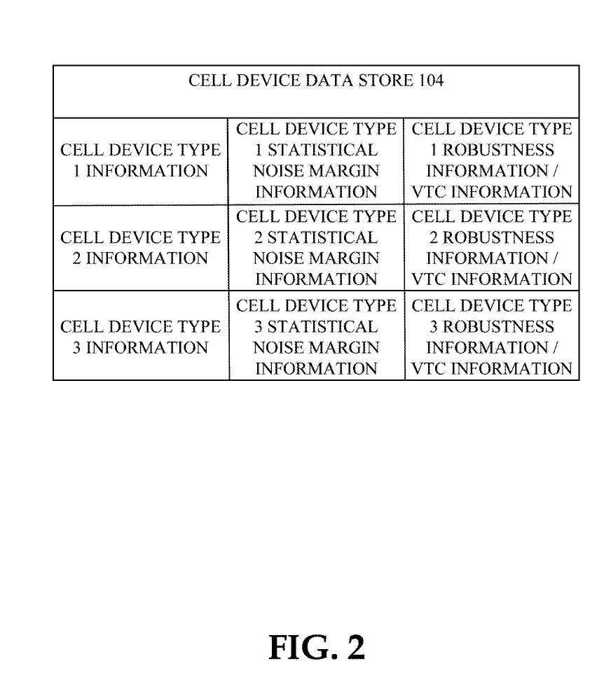

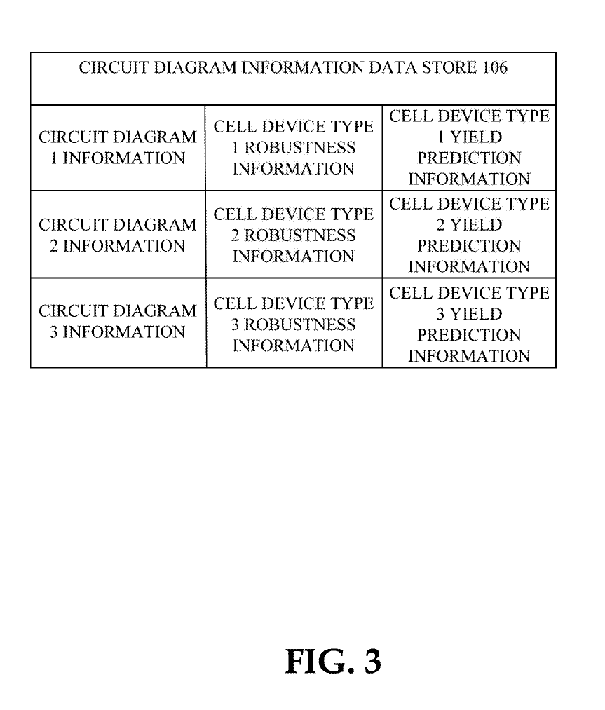

Turning now to the drawings, FIG. 1 illustrates an example block diagram of a system configured to facilitate determination of electronic circuit robustness in accordance with one or more embodiments described herein. FIG. 2 illustrates an example block diagram of cell device information stored within a cell device data store and employed by the system of FIG. 1 to facilitate determination of electronic circuit robustness in accordance with one or more embodiments described herein. FIG. 3 illustrates an example block diagram of circuit diagram information stored within a circuit diagram information data store and employed by the system of FIG. 1 to facilitate determination of electronic circuit robustness in accordance with one or more embodiments described herein.

Turning first to FIG. 1, system 100 can include device 102, cell device data store 104 and/or circuit diagram information data store 106. In various embodiments, device 102 can be electrically and/or communicatively coupled (or otherwise operationally coupled) to one or more of cell device data store 104 and/or circuit diagram information data store 106 to perform one or more functions or operations of device 102 and/or system 100.

System 100 can facilitate determination of cell device and/or circuit robustness in various embodiments. In some embodiments, system 100 can also facilitate generation yield prediction information for a circuit analyzed by device 102 based on robustness of the circuit. Further, in some embodiments, system 100 can facilitate generation of circuit design information such as identification of specific cell devices and interconnections of cell devices to design circuits that satisfy defined conditions relative to robustness, probability of circuit failure or other factor(s).

As shown, device 102 can receive cell device information from cell device data store 104. In some embodiments, cell device data store 104 may be a cell device library storing information about one or more cell devices that can be selected for design of an electronic circuit. For example, in some embodiments, cell device data store 104 may be or may include an electronic design automation cell device electronic library.

With reference to FIGS. 1 and 2, cell device information can include any number of different types of information that describe a type of the cell device. The information indicating the type of cell device can include, but is not limited to, text, symbols, data or other information descriptive of the components or materials or interconnections of the cell device. By way of example, but not limitation, cell devices can include logic gates (e.g., NAND2 gates, NOR2 gates, or other types of gates and configurations thereof), transistors, inverters (e.g., cross-coupled inverter, chain of inverters, or other types of gates and configurations thereof), memory devices, registers or any number or type of other devices that may be employed in the design of electronic circuits. As used herein, a “NAND2” gate means a 2-input NAND gate (as opposed to a NAND gate having a number of inputs other than two inputs). As used herein, a “NOR2” gate means a 2-input NOR gate (as opposed to a NOR gate having a number of inputs other than two inputs).

Further, in the embodiment shown, cell device information may be received at device 102 from cell device data store 104. However, in various embodiments, device 102 can receive cell device information from any number of different sources including, but not limited to, as information entered or provided to device 102 via an input device (e.g., mouse, keyboard) or via network connection.

In response to receipt of the cell device information, device 102 can perform statistical analysis to generate statistical information descriptive of the robustness of the cell device. In particular, device 102 can describe the robustness of the cell device as relates to parameter variation for the cell device when noise is experienced by the cell device. The parameters for which variation can occur for a cell device can be any number of different parameters including, but not limited to, channel length variation, oxide thickness variation, dopant concentration variation of the cell device (or a component of the cell device), or other type of variation(s) and combination(s) thereof.

Device 102 can determine cell device robustness information and/or one or more VTCs for the cell device based on the cell device robustness determination, and associate the one or more VTCs with the cell device. For example, in some embodiments, information indicative of one or more VTCs for a cell device can be stored by device 102 in the cell device data store 104 with statistical noise margin information for the cell device. Accordingly, device 102 can determine a VTC for a cell device based on variation of a parameter (e.g., channel length) when noise is experienced by the cell device.

As shown in FIG. 2, in some embodiments, the type of cell device, statistical noise margin information and robustness information and/or VTC information can be stored (for instance by device 102) in cell device data store 104 in some embodiments. In other embodiments, information indicative of one or more VTCs for a cell device can be associated with an identifier and stored in a location other than cell device data store 104. For example, the information indicative of the one or more VTCs and the identifier can be stored in device 104 or at a data store remote from cell device data store 104.

As also shown in FIG. 1, device 102 can receive circuit diagram information descriptive of one or more cell devices of a circuit and, in some embodiments, interconnections between the one or more cell devices. In various embodiments, any number of different arrangements of text, cell device or other symbols, graphical information or the like can be provided to describe the composition of a circuit. In some embodiments, circuit diagram information can be a netlist. While the embodiment of FIG. 1 illustrates the circuit diagram information being received at device 102 from circuit diagram information data store 106, in other embodiments, as with cell device information, circuit diagram information can be received from other sources such as via input devices and/or via network connection from sources remote from device 102.

Circuit diagram information can be received after, currently with or prior to determination of cell device robustness and/or VTC information; however, device 102 can determine or identify robustness information and/or VTC information for one or more cell devices of the circuit diagram prior to determining circuit robustness. For example, the information can be previously-determined by device 102 prior to receipt of circuit diagram information or determined after receipt of circuit diagram information.

Device 102 can determine information indicative of the robustness of a circuit composed of one or more cell devices for which robustness information has been generated. For example, device 102 can receive and/or access circuit diagram information for a circuit having one or more cell devices for which device 102 has generated robustness information (or for which device 102 can generate robustness information after receipt of the circuit diagram information).

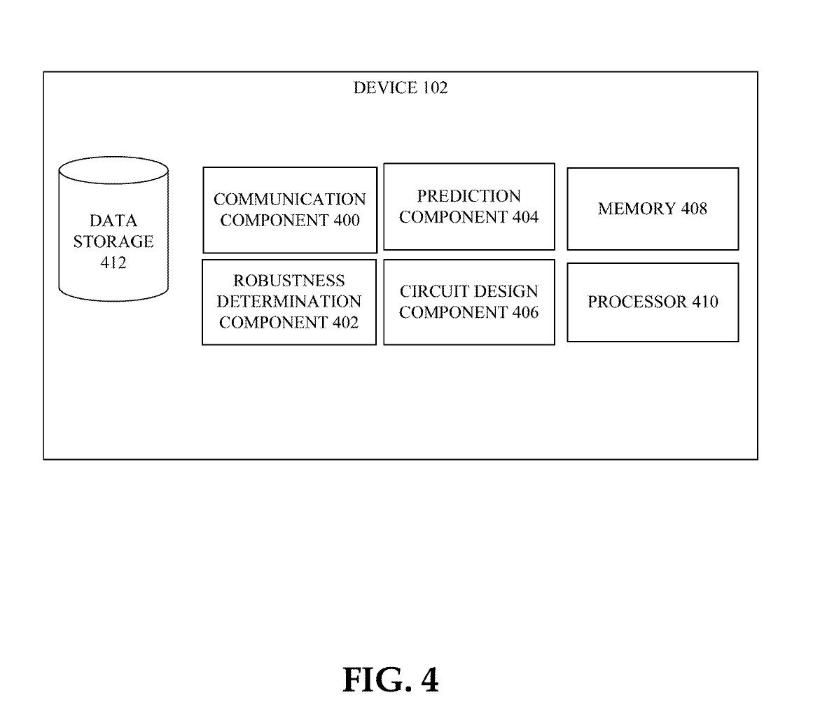

Device 102 can determine the robustness of the circuit based on an accumulation of robustness data for one or more of the cell devices of which the circuit is composed. Methods for determination of circuit robustness will be described in greater detail with reference to FIGS. 4. In this regard, for example when circuit diagram information is provided via a netlist, the method of determining robustness can be linear in the number of edges in a netlist graph. The edges of the netlist graph refer to the logical input to the output connections (e.g., wires) between logic gates.

In some embodiments, device 102 can store robustness information for the circuit in circuit diagram information data store 106. In other embodiments, device 102 can store the information at device 102 and/or at a data store located remote from circuit diagram information data store 106.

In some embodiments, device 102 can employ the robustness information for a circuit to predict yield of the circuit.

In some embodiments, device 102 can employ the robustness information for a circuit to generate circuit design information descriptive of a circuit design including one or more cell devices or including one or more circuits for which device 102 has generated robustness information. For example, in some embodiments, device 102 can generate circuit design information including details of particular cell devices, place and route to yield a defined desired circuit performance. For example, device 102 can select one or more of the cell devices of the candidate cell devices based on the determined characteristics or robustness data for the candidate cell devices.

As shown in FIG. 1, circuit robustness information can be output from device 102, and therefore can be transmitted to one or more other systems or devices for circuit design, performance evaluation, modeling, or other use(s). However, as described above, in some embodiments, device 102 can perform yield prediction based on robustness information generated for the circuit for which circuit diagram information is received by device 102.

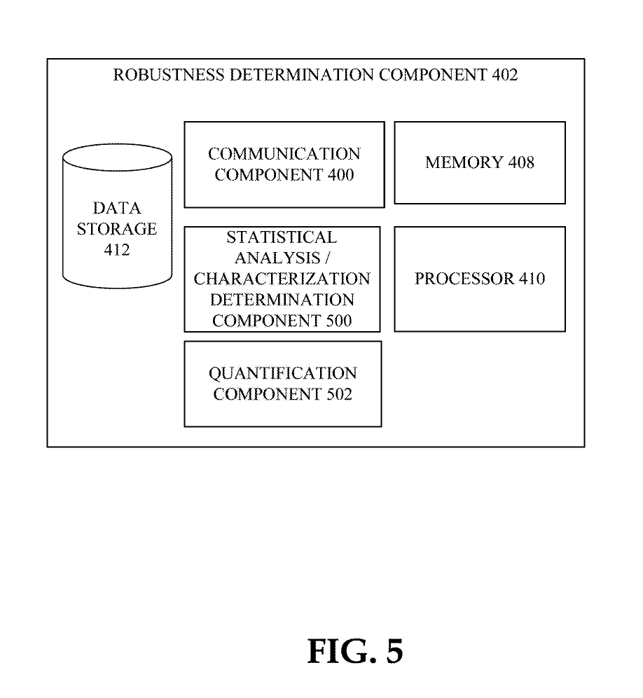

Details associated with determination of cell device and/or circuit robustness and/or yield prediction will be described in greater detail with reference to FIG. 4. FIG. 4 illustrates an example block diagram of a device of the system of FIG. 1 and configured to facilitate determination of electronic circuit robustness in accordance with one or more embodiments described herein. FIG. 5 illustrates an example block diagram of a robustness determination component of the device of FIG. 4 and configured to facilitate determination of electronic circuit robustness in accordance with one or more embodiments described herein. Repetitive description of like elements employed in respective embodiments of systems and/or apparatus described herein are omitted for sake of brevity.

Methods of computing robustness for cross-coupled inverters (for example) are provided followed by methods of computing robustness for chains of inverters (for example) and finally methods of computing robustness for gates, generally and for example. As shown in FIG. 4, device 102 can include communication component 400, robustness determination component 402, prediction component 404, circuit design component 406, memory 408, processor 410 and/or data storage 412. In various embodiments, one or more of communication component 400, cell device robustness determination component 402, circuit robustness component 404, circuit design component 406, memory 408, processor 410 and/or data storage 412 can be electrically and/or communicatively coupled (or otherwise operatively coupled) to one another to perform one or more functions or operations of device 102. The various elements/components of device 102 (as well as other elements/components shown in the various Figures) can be implemented in hardware, software (or other computer-readable instructions stored on a non-transitory computer readable medium and executable by one or more processors), or a combination of hardware and software (or other computer-readable instructions).

Communication component 400 can transmit and/or receive information to and/or from device 102. For example, in various embodiments, communication component 400 can receive text, alphanumeric information, symbols representative of cell devices or circuits, or other types of information and combination(s) thereof. For example, the text can be a description of a cell device or circuit. In some embodiments, communication component 400 can receive or access statistical information previously-generated by device 102 and/or stored in a cell device data store or circuit diagram information source or data store.

Communication component 400 can transmit text or other information indicative of statistical information, an identity or descriptor of a cell device, an identity and/or descriptor of a circuit, or other types of information and combination(s) thereof. Communication component 400 can transmit information to a data store (e.g., cell device data store, circuit diagram information data store).

In various embodiments, although not shown, communication component 400 can receive and/or transmit information via a network (e.g., Internet, wireless local area network (WLAN), wire line connection, etc.), and/or via a direct electrical connection between a data store and device 102. In some embodiments, communication component 400 can transmit and/or receive information to/from an interface to which device 102 is electrically and/or communicatively coupled.

As also shown in FIG. 4, device 102 can include robustness determination component 402. Robustness determination component 402 can determine the robustness of a cell device and/or a circuit composed of one or more cell devices. The robustness can be based on the parameter variation and effects of noise on the cell device. In various embodiments, robustness determination component 402 can determine the robustness for an entire circuit based on robustness information for one or more of the cell devices from which the circuit is composed.

Robustness determination component 402 will be described in greater detail below and with reference to FIG. 5. As shown in FIG. 5, robustness determination component 402 can include communication component 400, statistical analysis/characterization component 500, quantification component 502, memory 408, processor 410 and/or data storage 412. In various embodiments, one or more of communication component 400, statistical analysis/characterization component 500, quantification component 502, memory 408, processor 410 and/or data storage 412 can be electrically and/or communicatively coupled (or otherwise operatively coupled) to one another to perform one or more functions or operations of robustness determination component 402.

Statistical analysis/characterization determination component 500 can perform statistical analysis based on a description of a cell device to obtain statistical information for the cell device. The statistical information generated can be indicative of the robustness of the cell device. The robustness of the cell device can be a measure that takes into account parameter variation of the cell device that is related to a noise of the cell device.

Parameter variation of the cell device can include or be a variation of any number of different aspects of the cell device and/or can depend on the particular type of cell device. For example, the parameter variation can include the channel length variation, oxide thickness variation, dopant concentration variation, or other parameter variation(s) and combination(s) thereof. Characteristics of cell devices such as channel length, oxide thickness, or dopant concentration can have significant deviations from their nominal values due to process-induced and intrinsic parameter fluctuations

Statistical analysis/characterization determination component 500 can also determine one or more VTCs to characterize the cell device. For example, statistical analysis/characterization determination component 500 can determine the characteristic based on the statistical information generated.

Quantification component 502 can generate robustness information for the cell device. In some embodiments, quantification component 502 can generate robustness information for a circuit including one or more cell devices. For example, quantification component 502 can determine or access a previously-determined robustness for the one or more cell devices. Quantification component 502 can aggregate robustness information for the different cell devices in the circuit and generate a robustness value for the entire circuit.

Robustness determination component 402 (and components thereof), statistical analysis characterization determination component 500 and quantification component 502 can be further described as noted below. In particular, robustness determination component 402 (and/or components thereof) can quantify cross-coupled inverter robustness, robustness for a chain of inverters, robustness for memory and robustness for a number of different types of gates.

### Determination of Cross-Coupled Inverter Robustness

Parameter variation and noise can have a significant impact on circuit robustness. As such, increasing parameter variation may tend to reduce robustness to noise. For example, for two circuits, C₁ and C₂, operating at the same supply voltage, C₁ may be more robust than C₂ if C₁ can tolerate more noise than C₂. Accordingly, as circuit noise increases, C₂ may fail to function before C₁ fails to function. With statistical parameter variation, the occurrence of failure can be represented in terms of probability of failure. Accordingly, robustness can be defined such that C₁ may be more robust than C₂ if, for the same quantity of noise in both circuits, the probability that C₁ fails is less than the probability that C₂ fails.

In the embodiments described herein, robustness determination component 402 can determine the probability of active device parametric failure and corresponding circuit robustness. Specifically, robustness determination component 402 can determine the probability of active device parametric failure in which a cell device (e.g., gate or memory) erroneously changes state between binary digital values due to parameter variation. Circuit noise may act to make these failures more likely.

In order to quantify functional failures due to variation and noise, a guideline can be determined that provides guidance on what it means for a gate or memory to change state. Toward this, consider the base digital assumption: the abstraction of networks of transistors as logic-gates, and logic-gates as Boolean functions over Boolean logic-values. This abstraction may use an example guideline of a mapping between logic-values and a physical quantity: the electrical potential of charge stored on capacitive gate nodes. In the simplest mapping, nodes near the supply rail potential, V_{DD}, may represent a logic-1, and nodes near ground (GND) may represent a logic-0. As used herein, V_{DD}, supply rail voltage, and supply rail potential are synonymous.

In a real CMOS circuit, no two gates may be identical. They may differ in function, topology, and sizing; and distinct instances of the same gate can differ because of parameter variation. Consider an inverter, for example. If a 0 is applied to its input, then a 1 may be typically produced on its output. Similarly, a 1 at the input may typically result in a 0 at the output. However, in some instances (e.g., intentional construction or parameter variation), two distinct inverters, INV₁ and INV₂, can have different outputs given the same inputs.

For example, for input voltages near V_{DD} or GND, INV₁ and INV₂ can behave logically identically and correctly (e.g., invert), but for some input voltage, V_{X}, between V_{DD} and GND, INV₁ can produce a 0 as an output while INV₂ produces a 1 as an output. In this situation, INV₁ and INV₂ interpret V_{X} differently. The situation can be further complicated when the notion of the output voltage level is considered. That is, for example, the output of INV₁ is really only a 0 when a subsequent gate interprets it as such, and so on down a chain of gates.

Since different gates can have different interpretations of input voltages, a mapping between voltage levels and logic values can be defined in terms of the manner in which a subsequent gate interprets the output (as opposed to using a global bound). That is, for example, if worst-case boundaries on voltages are a high voltage boundary, V_{H}, and a low voltage boundary, V_{L} (in which it is known that all gates in a circuit interpret voltages above V_{H} as a 1 and all voltages below V_{L} as 0), then the mapping of V(G)>V_{H}⇄1 and V(G)<V_{L}⇄0 can be sufficient for some notion of correct operation, but it is not necessary. As used herein, V(G) refers to the voltage applied to the input node of a gate.

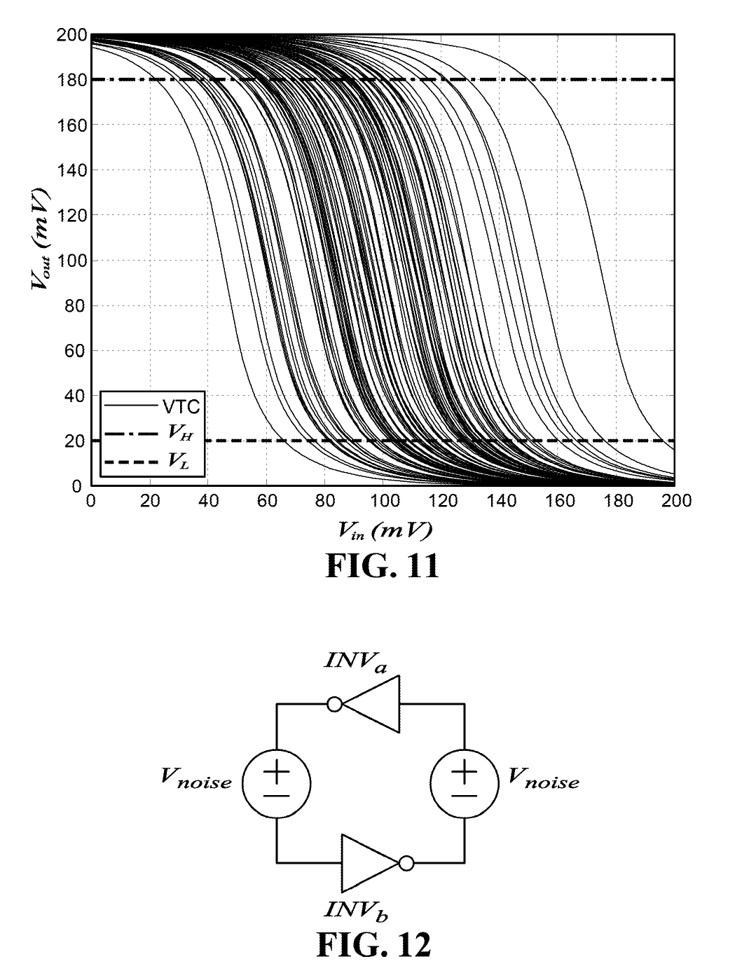

Consider an example that demonstrates the trouble with using the worst-case definitions for V_{H} and V_{L} in low-voltage applications. FIG. 11 illustrates an example graph of statistical voltage transfer characteristics (VTCs) for 100 Monte Carlo trials of a minimum-size inverter and which may be employed for determination of electronic circuit robustness in accordance with one or more embodiments described herein. Specifically, FIG. 11 illustrates 100 instances of a minimum-size inverter in a modern 40 nanometer (nm) low-power bulk CMOS process with V_{DD}=200 millivolts (mV) at 25 degrees Celsius (° C.) (typical-typical) TT-Corner. The curves vary significantly due to random parameter variation. These statistical VTCs have remarkably similar shapes and are nearly identical modulo horizontal translation. As such, it can be reasonable to consider defining V_{H}=180 mV and V_{L}=20 mV as worst-case output high and low voltages, respectively (these boundaries are also depicted by the dash-dot and the dashed lines, respectively in FIG. 11). However, worst-case can result in ranges that overlap.

In some embodiments, device 102 can employ statistical noise margin (SNM) analysis to determine circuit robustness. FIG. 12 illustrates an example circuit of a cross-coupled inverter pair and direct circuit noise voltage sources for which electronic circuit robustness can be determined in accordance with one or more embodiments described herein. The SNM of this cross-coupled pair may represent the largest DC noise voltage, Vₙₒᵢₛₑ, that can be applied between the bistable pair before the inverters switch state (e.g., between logic-0 and logic-1). If the SNM of a cross-coupled pair is less than or equal to zero (e.g., due to parametric variation), then the pair may not be bistable; is the cell may be unable to hold two distinct logic states (a functional failure). If the SNM of the pair is infinitesimally greater than zero, then the cell can hold two distinct logic states, but a diminutive noise can act to switch these states, so the cell may not be robust. Given that noise may be typically present, in some embodiments, a cross-coupled pair of inverters in a digital system may be designed to have static noise margins in excess of the system noise in order to maintain state. In some embodiments, in real memories (e.g., static random access memory (SRAM) arrays), the SNM during both reading and writing of cells may be considered. Furthermore, ensuring a SNM of greater than zero may be typical, but it may not be sufficient for ensuring read stability and write-ability.

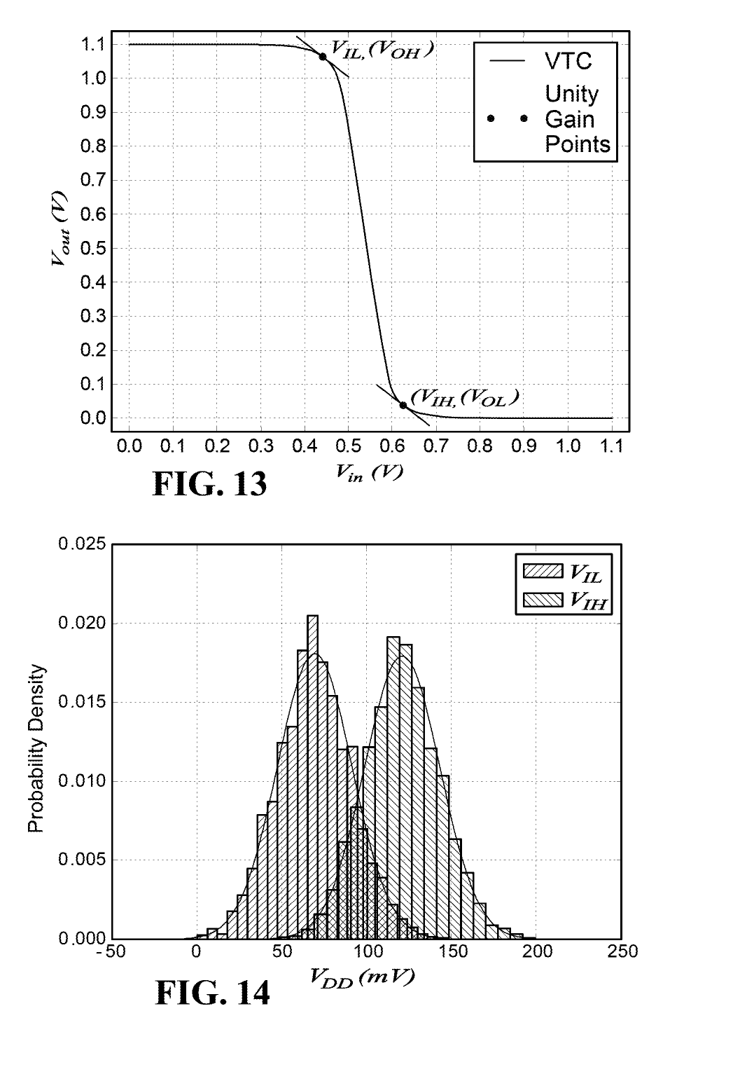

FIG. 13 illustrates an example graph of statistical voltage transfer characteristics for a minimum-size inverter and which may be employed for determination of electronic circuit robustness in accordance with one or more embodiments described herein, and more specifically, FIG. 13 shows an example VTC for a minimum-size inverter in a commercial 40 nm low-power CMOS process (V_{DD}=1.1 volts (V) at 25° C.). Device 102 can identify the unity gain points of the inverter shown in FIG. 13 to define the statistical VTC parameters: maximum output voltage, Vo_{H}, miniumum output voltage, V_{OL}, maximum input voltage, V_{IH}, and minimum input voltage, V_{IL}.

Statistical analysis/characterization determination component 500 can perform statistical analysis on the unity gain points

$$( e . g . , \vert \frac{d {V}_{out}}{d {V}_{in}} \vert = 1 )$$

of the statistical VTCs to measure the SNMs for the inverter. As used herein, dVₒᵤₜ and dVᵢₙ mean the change in Vₒᵤₜ and the change in Vᵢₙ, RESPECTIVELY. For example, with reference to FIGS. 12 and 13, INVₐ (INV_{b}) can represent a static CMOS inverter having a single negative channel field effect transistor (NFET) and positive channel field effect transistor (PFET) with the statistical VTC depicted in FIG. 13.

The functionality of the inverter and/or the definition of SNM can rely on two properties of the statistical VTC holding: (1) two unity gain points exist and (2) the slope between the unity gain points exceeds unity in absolute value. From these unity gain points, four properties of an inverter statistical VTC can be defined: Vo_{H}, V_{OL}, V_{1H}, V_{1L}, as shown in FIG. 13. These four points may be referred to as statistical VTC parameters throughout.

The statistical VTC parameters can identify definable boundaries between the voltages that are interpreted as a logic-1 or logic-0, and the undefined region of high-gain in between. That is, V_{1H} can be considered the lowest voltage that the inverter correctly interprets as a 1 and V_{1L} as the highest voltage that it correctly interprets as a 0. Similarly, V_{OH} can be considered the lowest voltage that the inverter will output as a 1, and V_{OL} the highest voltage that the inverter will output as a 0.

In general, when one gate drives another gate, a static noise margin can be defined. This static noise margin can be separated into two components: a noise margin high (NM_{H}) and a noise margin low (NM_{L}) (one for each logic value). Consider a pair of inverters, with INVₓ driving INV_{y}. The two components of the corresponding noise margin can be defined as shown in Equations 1 and 2 below:

NM_{H}(INVₓ−INV_{y})=V_{OH}(INVₓ)−V_{IH}(INV_{y}) (Equation 1).

NM_{H}(INVₓ−INV_{y})=V_{OH}(INVₓ)−V_{IH}(INV_{y}) (Equation 2).

The static noise margin can be defined as the smaller of NM_{H} or NM_{L}. Equation 3 can result.

SNM(INVₓ,INV_{y})=min(NM_{L}(INVₓ,INV_{y}),NM_{H}(INVₓ,INV_{y})) (Equation 3).

The relationships in Equations 1, 2 and 3 can be implicit functions of V_{DD}. For cross-coupled inverters, as in FIG. 12, INVₐ may drive INV_{b}, and INV_{b} may drive INVₐ and, as such, two different static noise margins can be defined, SNM (INVₐ, INV_{b}) and SNM (INV_{b}, INVₐ). Employing assumptions that the statistical VTCs may be monotonic and may have a single inflection point, the condition that SNM (INVₐ, INV_{b})>Vₙₒᵢₛₑ∩SNM (INV_{b}, INVₐ)>Vₙₒᵢₛₑ can be, in some embodiments, a sufficient condition for differentiation of binary logic-values by way of the electrical potential stored on the output of each inverter.

The SNM of the cross-coupled inverters, extended to incorporate parametric variability, and generalized to apply to various different types of gates, can be employed by quantification component 502 to quantify circuit robustness. In particular, statistical analysis/characterization determination component 500 and/or quantification component 500 can define a robustness metric for cross-coupled inverters that includes parameter variation and noise by way of a statistical noise margin constraint.

As described above, when considering two different circuits, C₁ and C₂, operating with the same supply voltage, C₁ may be more robust than C₂ if for the same quantity of noise in both circuits the probability that C₁ fails is less than the probability that C₂ fails. That is, for two different circuits C₁ and C₂, the relationship described by Equation 4 may be true:

ROB(C₁)>ROB(C₂)⇄P(FAIL((C₁))<P(FAIL((C₂)) (Equation 4).

where ROB refers to circuit robustness and FAIL refers to circuit failure.

Switching noise in digital circuits can be estimated and reduced/optimized at some cost; e.g., spreading wires reduces coupling noise at the expense of area. As such, the circuit designer can choose a noise margin target, NM_{T}. Noise margin target can be the minimum noise margin constraint for all gates. A unique noise margin target can be chosen for one or more (or all) of the gates (if desired). In this way, noisy gates can be assigned larger targets than quiet gates. In the embodiments described herein, statistical analysis/characterization determination component 500 can operate according to the assumption that if any gate has a noise margin less than or equal to the NM_{T}, then the gate is said to fail, as is the entire circuit containing the failing gate.

Consider a cross-coupled inverter-pair, INVₐ and INV_{b}, (as in FIG. 12 with Vₙₒᵢₛₑ=0V) operating at a particular V_{DD}. The probability of failure for a pair can then be defined as shown in Equation 5:

P(FAIL(INVₐ,NM_{T})∪FAIL(INV_{b},NM_{T})=P(SNM((INVₐ,INV_{b})≦NM_{T}∪SNM(INV_{b},INVₐ)≦NM_{T}) (Equation 5).

For a circuit, Cₐ, having n cross-coupled inverter-pairs, e.g., Cₐ=(INVₐⁱ, INV_{b}ⁱ) for iε{1, 2, . . . , n}, Equation 6 can result:

P(FAIL(Cₐ,NM_{T}))=P(U_{iε{1,2, . . . ,n}}FAIL(INVₐⁱ,NM_{T})∪(INV_{b}ⁱ,NM_{T}) (Equation 6).

As such, robustness can be determined, by quantification component, for a cross-coupled inverter pair cell device by application of Equations 5 and 6. The relationships shown in Equations 5 and 6 can treat both the probability of failure and SNM as random variables (RVs). However, to compute the values for the variables in Equations 5 and 6, the corresponding distributions and the effects of correlation are considered below.

Distributions and effects of correlation can be determined based on an analysis of one or more statistical VTC parameters. Device parameter variation can result in variation in the SNMs of inverters, gates, etc. The precise relationship can be based on the type of parameter variation and the device operating regime (e.g., subthreshold and above threshold). As described, the variation in SNM can be analyzed in terms of NM_{H} and NM_{L} variation (see Equation 3). Similarly, NM_{H} and NM_{L} can be considered in terms of the corresponding statistical VTC parameters, V_{OH}, V_{1H} and V_{OL}, V_{1L} associated with NM_{H} and NM_{L} (see Equations 1 and 2).

In modern bulk CMOS technologies, the output statistical VTC parameters of a gate, V_{OH} and V_{OL}, can be considered regular (not random) variables. In some embodiments, evaluating first-order effects, V_{OH} and V_{OL} can be considered global constants dependent on temperature when operating in the subthreshold regime. Including second order effects and near-threshold operation can induce a dependence on V_{DD} and gate topology, in some embodiments. As such, V_{OH} and V_{OL} may be treated as regular variables in the embodiments described herein while the input statistical VTC parameters, V_{1H} and V_{1L}, may be treated as normal random variables.

Referring to FIG. 11 for a particular gate (an inverter) operating at a particular supply voltage (e.g., 200 mV), the output statistical VTC parameters, V_{OH} and V_{OL}, may be nearly constant and close to V_{DD} and GND, respectively (consider the dash-dot and dashed lines). The horizontal translation between this family of statistical VTC curves, which can be due to random parameter variation, can correspond to shifts in the input statistical VTC parameters, V_{1H} and V_{1L}.

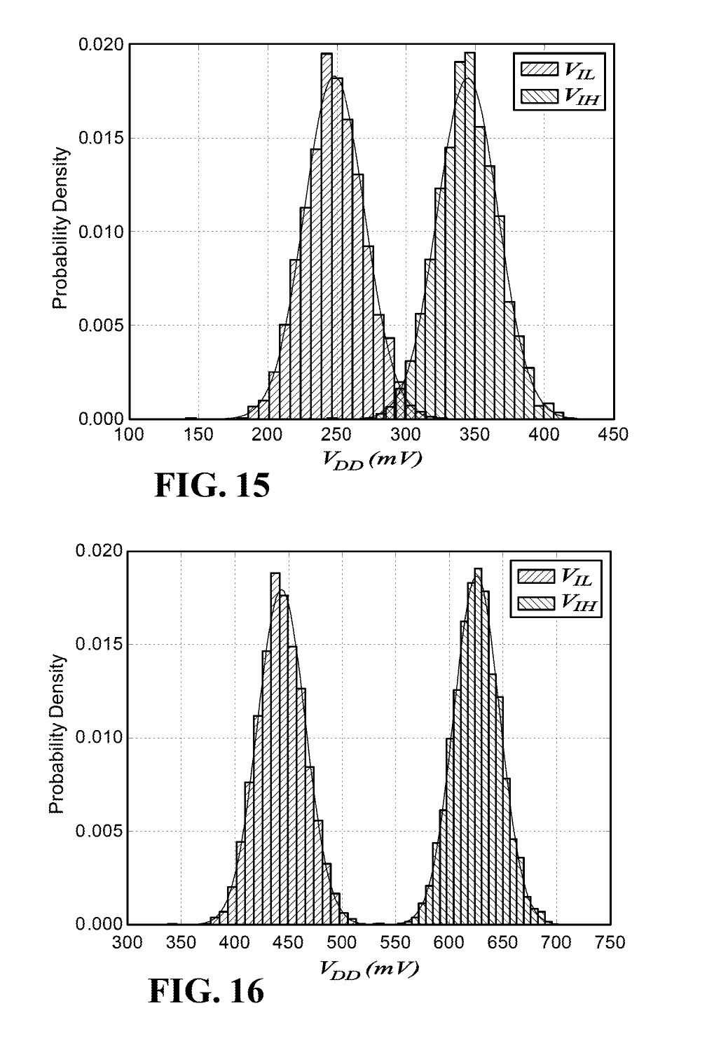

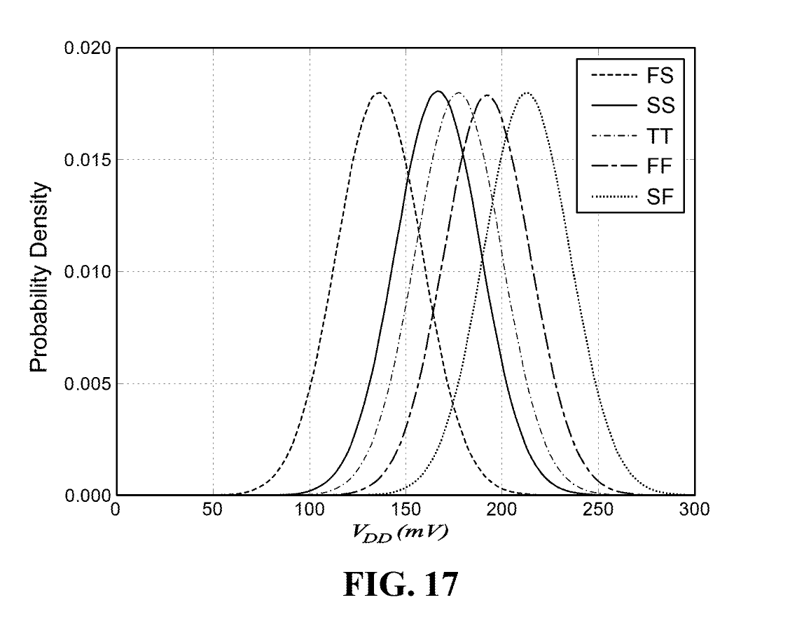

FIGS. 14, 15, 16 and 17 illustrate example graphs depicting probability density distributions for input parameters for an inverter at respective values of V_{DD} values, and which may be employed for determination of electronic circuit robustness in accordance with one or more embodiments described herein. In FIG. 14, shown are example V_{1H} and V_{1L} distributions for a minimum-size inverter in a commercial 40 nm low-power CMOS process at the TT-Corner (V_{DD}=200 mV at 25° C.). In FIG. 15, shown are example V_{1H} and V_{1L} distributions for a minimum-size inverter in a commercial 40 nm low-power CMOS process at the TT-Corner (V_{DD}=600 mV at 25° C.). In FIG. 16, shown are examples of the the V_{1H} and V_{IL} distributions for a minimum-size inverter in a commercial 40 nm low-power CMOS process at the TT-Corner (V_{DD}=1.1V at 25° C.). In FIG. 17, shown are examples of the V_{1H} distributions for a minimum-size inverter in a commercial 40 nm low-power CMOS process (V_{DD}=300 mV at 25° C.). Global variation may shift the mean value for both V_{1H} and V_{1L}.

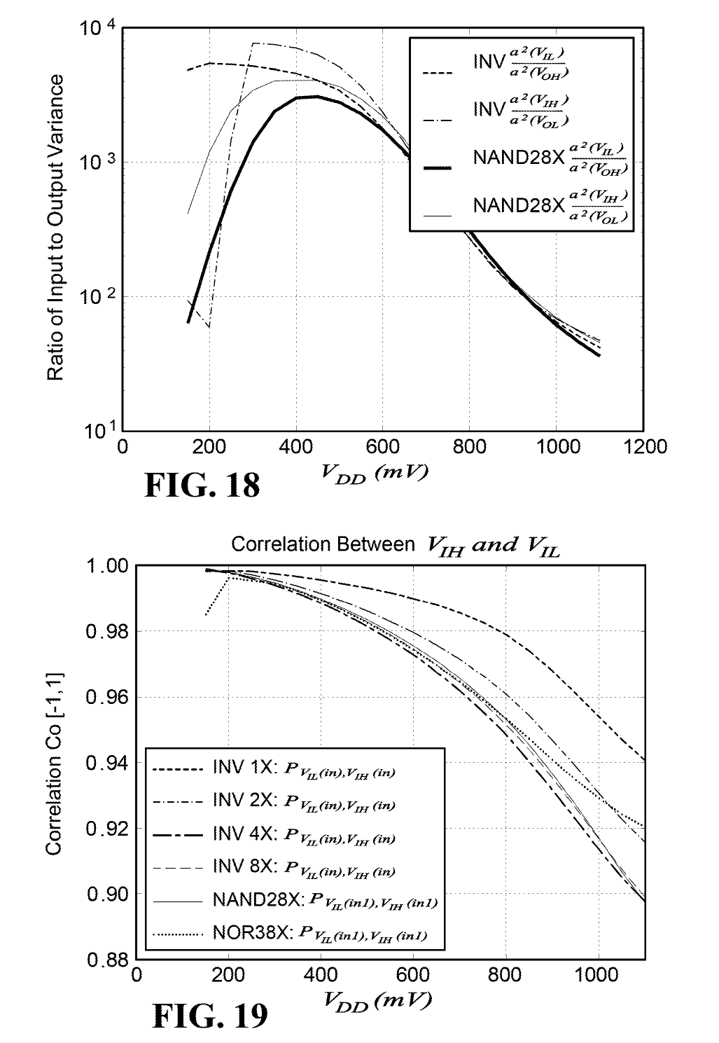

FIG. 18 illustrates example graphs of a ratio of input VTC parameter variance to output VTC parameter variance in a CMOS for determination of electronic circuit robustness in accordance with one or more embodiments described herein. Specifically, FIG. 18 shows an example of the ratio of input statistical VTC parameter variance to output statistical VTC parameter variance in a commercial 40 nm low-power CMOS process (25° C., TT-Corner).

The large ratio across the entire operating range can facilitate approximation of the output statistical VTC parameters as regular variables, whereas the input statistical VTC parameters may be considered random variables.

The input statistical VTC parameters may be normally distributed with mean and standard deviation determined by the supply voltage, gate topology, temperature, and/or global corner. This may be shown by the analysis of two standard cell libraries in different technologies and from different foundries (e.g., a 40 nm low-power process and a 65-nm low-power process). Both cell libraries may contain hundreds of cell devices, and Anderson-Darling normality testing may show that neither V_{1H} nor V_{1L} have any significant departure from normality over the entire operating range. The Anderson-Darling normality test is a statistical test of whether a given sample of data is drawn from a given probability distribution. Furthermore, it can be difficult to verify that the tails of purportedly normal distributions are actually normal; as such, treating V_{1H} and V_{1L} and normal RVs can be considered an approximation.

FIGS. 14, 15 and 16 depict example V_{1H} and V_{1L} histograms along with corresponding normal probability density functions (PDFs) for a minimum-size inverter operating sub-threshold, near threshold and at process nominal V_{DD}, respectively. Global variation can skew the mean value, as depicted in FIG. 17. FIG. 18 further supports the treatment of the output VTC parameters as regular variables because the spread of each input VTC parameter may be several orders of magnitude greater than the corresponding output VTC parameter spread.

At any particular global corner, local parameter variation can be uncorrelated. As such, the statistical VTC parameters for distinct inverters, gates, etc. can be independent. Consider two distinct inverters, INVₓ driving INV_{y}; INVₓ and INV_{y} have independent normally distributed input statistical VTC parameters. From Equations 1 and 2 and the assumption that the corresponding output statistical VTC parameters may be regular variables, it follows that the corresponding NM_{H} and NM_{L} may also be normally distributed random variables (RVs) with mean and standard deviation given by Equations 7 and 8 shown below:

μ(NM_{H}(INVₓ,INV_{y})=V_{OH}(INVₓ)−μ(V_{IH}(INV_{y})),σ(NM_{H}(INVₓ,INV_{y}))=σ(V_{IH}(INV_{y})) (Equation 7).

μ(NM_{L}(INVₓ,INV_{y})=μ(V_{IL}(INV_{y})−V_{OL}(INVₓ)),σ(NM_{L}(INVₓ,INV_{y}))=σ(V_{IL}(INV_{y})) (Equation 8).

where for any RV Z, μ(Z) and σ(Z) denote the mean value of the random variable and the standard deviation of the random variable, respectively. However, the statistical SNM may not follow directly from Equation 3 (due to the min function). If NM_{H}(INVₓ, INV_{y}) and NM_{L}(INVₓ, INV_{y}) are independent, order statistics can be used by quantification component 502 to directly calculate SNM(INVₐ, INV_{b}). However, in some embodiments, NM_{H}(INVₓ, INV_{y}) and NM_{L}(INVₓ, INV_{y}) may not be independent.

FIG. 19 illustrates example graphs of correlation between input parameters for determination of electronic circuit robustness in accordance with one or more embodiments described herein. Specifically, FIG. 19 shows an example correlation between V_{1H} and V_{1L} in a commercial 40 nm low-power CMOS process (25° C., TT-Corner). These input statistical VTC parameters may be highly positively correlated across V_{DD} for a wide variety of gates. From FIG. 19, it is clear that the input statistical VTC parameters may be highly positively correlated, and it follows from this and Equations 7 and 8 that NM_{H} and NM_{L} may be highly negatively correlated, which can make the direct calculation of SNM difficult.

In embodiments described herein, quantification component 502 can employ NM_{H} and NM_{L} directly to calculate the probability that a circuit fails, thus avoiding the need to compute SNM. In this way, the effects of correlation can be accounted for, and a general method for failure analysis is made possible.

The failure probability, and thus robustness, of a cross-coupled inverter pair can be computed by quantification component 502 as follows. Again, consider a cross-coupled inverter-pair, INVₐ and INV_{b}, (as in FIG. 12 with Vₙₒᵢₛₑ=0V) operating at a particular V_{DD} and with a noise margin target of NM_{T}.

Quantification component 502 can calculate the probability of failure from Equation 5 by evaluation of P(SNM(INVₐ, INV_{b})≦NM_{T}∪SNM(INV_{b}, INVₐ)≦NM_{T}). Assuming statistical independence, the disjunction can be treated as an addition, and Equation 5 reduces to Equation 9 shown below:

P(FAIL(INVₐ,NM_{T})∪FAIL(INV_{b},NM_{T})=P(SNM((INVₐ,INV_{b})≦NM_{T}+P(SNM(INV_{b},INVₐ)≦NM_{T}) (Equation 9).

To calculate this quantity in closed-form, Equation 9 can be re-termed by using NM_{H} and NM_{L} in lieu of SNM. In order to do this, upper and lower bounds on failure may be determined, and then an approximation may be given.

The upper bound on failure for a cross-coupled inverter pair can be determined as follows. If SNM(INVₐ, INV_{b})≦NM_{T}, then NM_{H}(INVₐ, INV_{b})≦NM_{T} and/or NM_{L}(INVₐ, INV_{b})≦NM_{T} (following directly from Equation 3). This can be stated in terms of probabilities as shown in Equation 10 below:

P(SNM(INVₐ,INV_{b})≦NM_{T})≦P(NM_{H}(INVₐ,INV_{b})≦NM_{T}∪NM_{L}(INVₐ,INV_{b})≦NM_{T}) (Equation 10).

Due to the high degree of anti-correlation between NM_{H} and NM_{L}, the disjunction can be approximated as an addition as shown in Equation 11 below:

P(SNM(INVₐ,INV_{b})≦NM_{T})≦P(NM_{H}(INVₐ,INV_{b})≦NM_{T}+P(NM_{L}(INVₐ,INV_{b})≦NM_{T}) (Equation 11).

Due to symmetry, a similar argument can hold for SNM(INV_{b}, INVₐ), so combining Equations 9 and 11 can yield an upper bound on the probability of failure for cross-coupled inverters. That is, the upper bound on the probability for failure for a cross-coupled inverter pair can be as shown in Equation 12:

P(FAIL(INVₐ,NM_{T})∪FAIL(INV_{b},NM_{T})≦P(NM_{H}(INVₐ,INV_{b})≦NM_{T})+P(NM_{L}(INVₐ,INV_{b})≦NM_{T})+P(NM_{H}(INV_{b},INVₐ)≦NM_{T})+P(NM_{L}(INV_{b},INVₐ)≦NM_{T}) (Equation 12).

The lower bound on failure for a cross-coupled inverter pair can be determined as follows. If NM_{H}(INVₐ, INV_{b})≦NM_{T} and NM_{L} (INVₐ, INV_{b})≦NM_{T}, then SNM(INVₐ, INV_{b})≦NM_{T} (following directly from Equation 3). This can be stated in terms of probabilities as shown in Equation 13 shown below:

P(SNM(INVₐ,INV_{b})≦NM_{T})>P(NM_{H}(INVₐ,INV_{b})≦NM_{T}∩(NM_{L}(INVₐ,INV_{b})≦NM_{T}) (Equation 13).

Due to the high degree of anti-correlation between NM_{H} and NM_{L}, the conditional probability of each event (NM_{H}(INVₐ, INV_{b})≦NM_{T}, and NM_{L}(INVₐ,INV_{b})≦NM_{T}) may be less than the unconditional probability, so Equation 14 results and is shown below:

P(SNM(INVₐ,INV_{b})≦NM_{T})>P(NM_{H}(INVₐ,INV_{b})≦NM_{T})*P(NM_{L}(INVₐ,INV_{b})≦NM_{T}) (Equation 14).

Due to symmetry, a similar argument can hold for SNM (INV_{b}, INVₐ). As such, combining Equations 9 and 14 can yield a lower bound on the probability of failure for cross-coupled inverters. That is, the lower bound on the probability for failure for a cross-coupled inverter pair can be as shown in Equation 15:

P(FAIL(INVₐ,NM_{T})∪FAIL(INV_{b},NM_{T}))>P(NM_{H}(INVₐ,INV_{b})≦NM_{T})*P(NM_{L}(INVₐ,INV_{b})≦NM_{T})+P(NM_{H}(INV_{b},INVₐ)≦NM_{T})*P(NM_{L}(INV_{b},INVₐ)≦NM_{T}) (Equation 15).

A heuristic approximation of the probability of failure for a cross-coupled inverter pair can be determined as follows. One way to approximate the probability of failure comes from the consideration of the cross-coupled inverter pair as a whole. If INV_{A} is skewed such that it can barely interpret a logical-0 and INV_{B} is skewed such that is can barely interpret a logical-1 (or vice versa), then a failure may be likely. That is, if NM_{H} (INVₐ, INV_{b})≦NM_{T} and NM_{L}(INV_{b}, INVₐ)≦NM_{T}, or if NM_{H}(INV_{b}, INVₐ)≦NM_{T} and NM_{L}(INVₐ, INV_{b})≦NM_{T}, then it may be likely that SNM(INVₐ, INV_{b})≦NM_{T} or SNM(INV_{b}, INVₐ)≦NM_{T}. Empirically, with a small shift, δ, the lower bound approximation (given by Equation 15) may lead to an accurate heuristic over a wide range of NM_{T} and V_{DD}. That is, Equation 16 results and is shown below:

P(FAIL(INVₐ,NM_{T})∪FAIL(INV_{b},NM_{T}))≈P(NM_{H}(INVₐ,INV_{b})≦NM_{T}+δ)*P(NM_{L}(INV_{b},INVₐ)≦NM_{T}+δ)+P(NM_{H}(INV_{b},INVₐ)≦NM_{T}+δ) (Equation 16).

Quantification component 502 can employ the Gauss error function, erf, and the cumulative distribution function (CDF) of the normal distribution to compute the probability of failure. If Z is a normal random variable with mean μ and standard deviation σ, and c a constant, then Equation 17 results and is shown below:

$$P ( Z \leq c ) = \frac{1}{2} ( 1 + erf ( \frac{c - μ}{σ \sqrt{2}} ) ) . \qquad ( Equation 17 )$$

Consider an inverter INVₓ driving another inverter INV_{y}, combining Equations 7, 8 and 17 yields Equation 18 shown below:

$$P ( ( {INV}_{x} , {INV}_{y} ) \leq ) = \frac{1}{2} [ 1 + erf ( \frac{- ( ( {INV}_{x} ) - μ ( ( {INV}_{y} ) ) )}{σ ( ( {INV}_{y} ) ) \sqrt{2}} ) ] \\ and \\ P ( ( {INV}_{x} , {INV}_{y} ) \leq ) = \frac{1}{2} [ 1 + erf ( \frac{- ( μ ( ( {INV}_{y} ) ) - ( {INV}_{x} ) )}{σ ( ( {INV}_{y} ) ) \sqrt{2}} ) ] . \qquad ( Equation 18 )$$

Quantification component 502 can apply Equation 18 directly to Equations 12, 15 and 16, thus yielding close-form equations for the probability of cross-coupled inverter failure. Accordingly, quantification component 502 can perform a method of computation that applies the variable values and relationships of Equation 18 to Equations 12, 15 and 16 to quantify robustness of a cross-coupled inverter pair.

Equations 18, 12, 15 and 16 may provide expressions for failure likelihood that use an extremely compact set of real numbers: V_{OH}(INV_{x,y}), V_{OL}(INV_{x,y}), μ(V_{IH}(INV_{x,y})), μ(V_{IL}(INV_{x,y})), σ(V_{IH}(INV_{x,y})), σ(V_{IL}(INV_{x,y})). That is, these are the parameters that may be employed in order to calculate the probability of failure, and hence robustness of a circuit.

Accordingly, for a cell device, quantification component 502 of robustness determination component 402 can generate VTC information and compute robustness based on performing a method based at least in part on Equations 18, 12, 15 and 16.

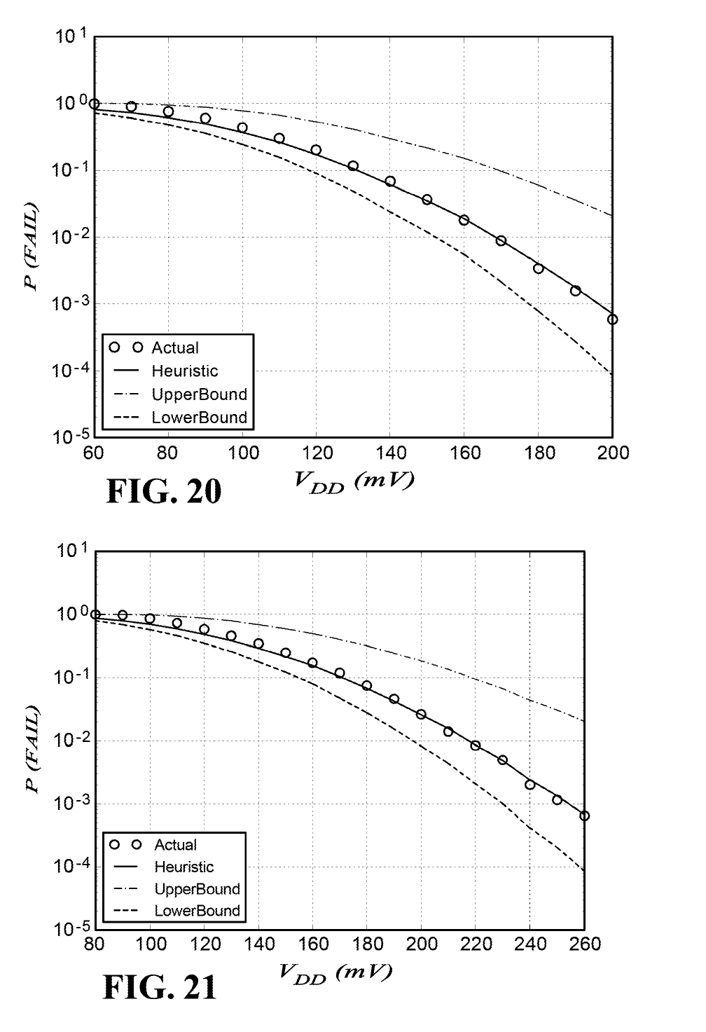

FIGS. 20, 21, 22, 23 and 24 illustrate example graphs depicting probabilities of minimum-size cross-coupled inverter-pair failure for respective noise margin threshold values for determination of electronic circuit robustness in accordance with one or more embodiments described herein. Specifically, FIGS. 20, 21 and 22 illustrate an example of the probability of failure for a crossed-coupled inverter pair against V_{DD}.

In particular, FIG. 20 illustrates an example of the probability of minimum-size cross-coupled inverter-pair failure for NM_{T}=0 mV in a commercial 40 nm low-power CMOS process (25° C., TT-Corner). For the heuristic approximation, the mean absolute error may be 13%, and the maximum absolute error may be 20% with δ=4.2% V_{DD}.

FIG. 21 illustrates an example of the probability of minimum-size cross-coupled inverter-pair failure for NM_{T}=10% V_{DD} in a commercial 40 nm low-power CMOS process (25° C., TT-Corner). For the heuristic approximation, the mean absolute error may be 12%, and the maximum absolute error may be 20% with δ=3.2% V_{DD},

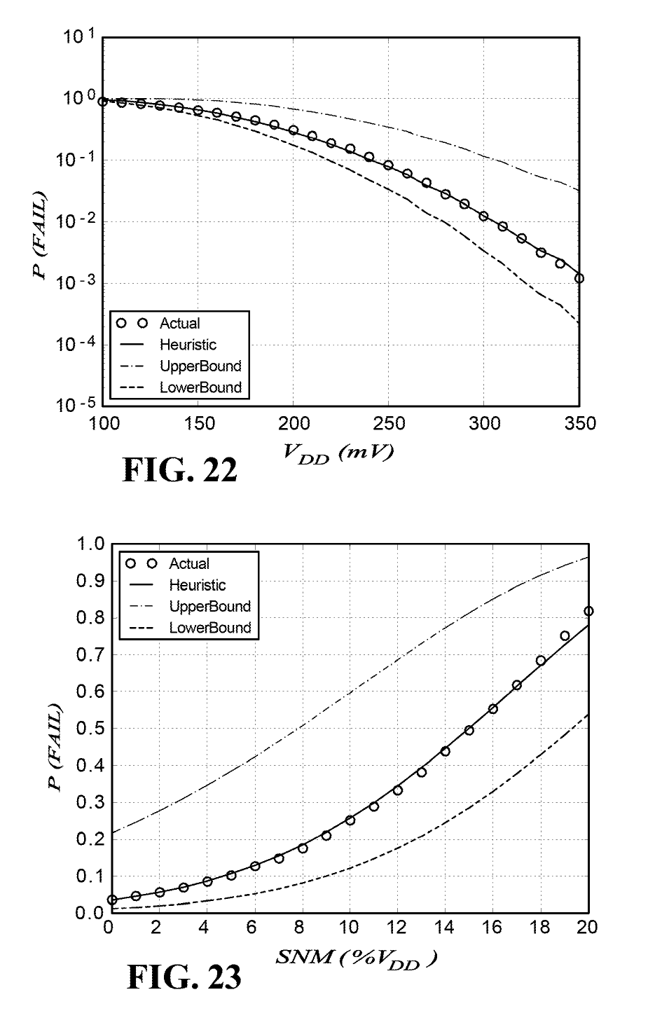

FIG. 22 illustrates an example of the probability of minimum-size cross-coupled inverter-pair failure for NM_{T}=20% V_{DD} in a commercial 40 nm low-power CMOS process (25° C., TT-Corner). For the heuristic approximation, the mean absolute error may be 5.2%, and the maximum absolute error may be 17% with δ=2.2% V_{DD},

FIG. 23 illustrates an example of the probability of minimum-size cross-coupled inverter-pair failure for V_{DD}=150 mV in a commercial 40 nm low-power CMOS process (25° C., TT-Corner). For the heuristic approximation, the mean absolute error may be 2.5%, and the maximum absolute error may be 5.5% with δ=4.3% V_{DD}.

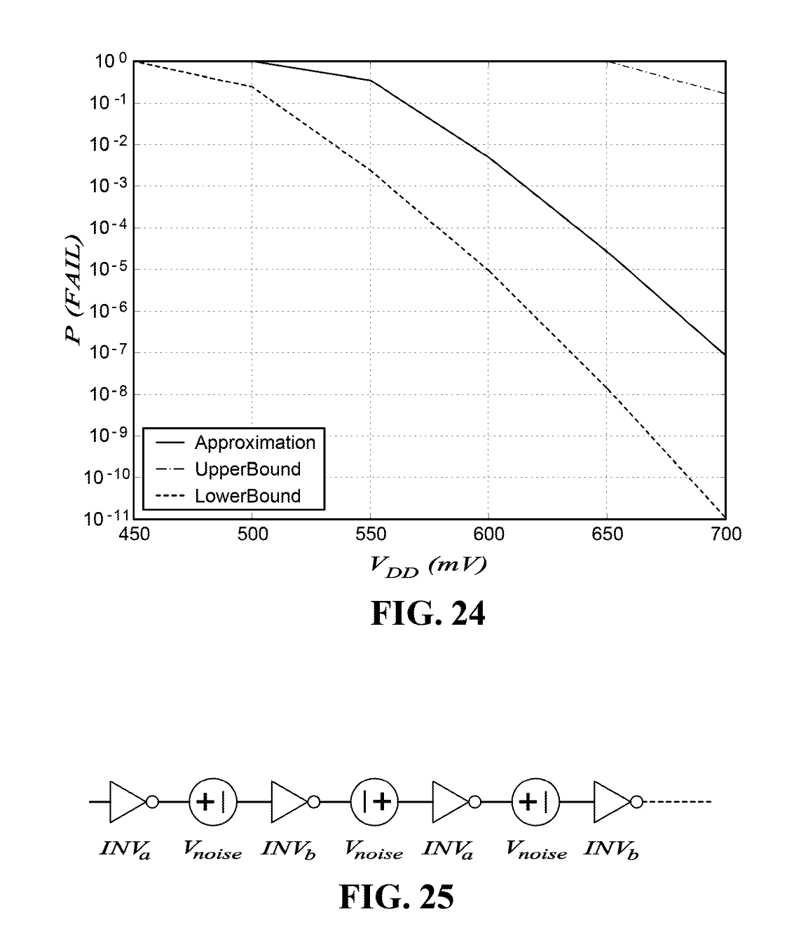

FIG. 24 illustrates an example of the probability of cross-coupled inverter failure versus NM_{T} for a fixed supply voltage of 150 mV. Digital noise may tend to be proportional to V_{DD}, so the NM_{T} may be reported as a percentage of V_{DD}. Each of these figures depicts the upper bound, lower bound, and approximation for cross-coupled inverter failure probability, in addition to the actual (empirical) failure rate. Actual failures may be calculated via Monte Carlo SPICE simulations with foundry provided statistical BSIM4 models. These models are statistical models provided by the foundry for the process being used/analyzed.

FIGS. 20, 21, 22 and 23 also serve to exemplify why an accurate and simple closed-form approximation for the probability of failure may be useful. In particular, in each of these plots, as V_{DD} increases linearly, the probability of failure may decrease exponentially, and the size of the Monte Carlo simulations employed to generate accurate failure rates may increase exponentially. With an NMT of 10% and V_{DD} at 300 mV the probability of failure may be already less than 10⁻⁵, so millions of Monte Carlo trials may need to be performed. A million such trials on modern computers with modern tools may involve several core-hours of compute time. Furthermore, it is not uncommon for a modern microprocessor design to contain millions of cross-coupled inverters, so higher supply voltages with lower failure rates on the order of 10⁻⁹ or lower may need to be considered. This corresponds to at least a four order of magnitude increase in computational time for a single temperature and V_{DD} of interest. To ensure reliability, multiple supply voltages and temperatures may be considered, thereby increasing the computation requirement by yet another order of magnitude. Optimization of transistor sizing can easily increase the computation requirement by another order of magnitude, thereby resulting in a computational requirement in the realm of millions of core-hours. Finally, this type of analysis may extend to arbitrary gates (typical standard cell device data stores/libraries containing hundreds of cell devices). This analysis may push the computation requirement to billions of core-hours. A closed-form approximation may be more practical.

In some embodiments, quantification component 502 can compute the probability of failure of a circuit Cₐ having n cross-coupled inverter pairs (Cₐ=(INVₐⁱ, INV_{b}ⁱ) for iε{1, 2, . . . , n}) as shown in Equation 19. Equation 6 can be re-written in terms of a global conjunction instead of disjunction and is shown as Equation 19

P(FAIL(Cₐ,NM_{T}))=1−P(U_{iΣ{1,2, . . . ,n}}−FAIL(INVₐⁱ,NM_{T})∪NM_{T}))) (Equation 19).

Given the assumption of statistical VTC parameter independence between gate pairs, the global conjunction can be treated as a product, given a readily computable compact expression for the probability of failure and hence robustness of a circuit, one of the goals of this section. That is, Equation 20 results and is shown below:

P(FAIL(Cₐ,NM_{T}))=1−P(Π_{iΣ{1,2, . . . ,n}}FAIL(INVₐⁱ,NM_{T})∪FAIL(INV_{b}ⁱ,NM_{T}))) (Equation 20).

FIG. 24 illustrates the probability of failure for 2e²⁸ minimum-size cross-coupled inverter-pairs with NM_{T}=20% V_{DD} in a commercial 40 nm low-power CMOS process (25° C., TT-Corner, and δ=2.2% V_{DD}). FIG. 24 gives the probability of failure for 2e²⁸ independent cross-coupled inverter pairs (e.g., a 32 MB memory).

With Equation 20, quantification component 502 can quantify the probability of failure, and hence robustness, for an entire memory. In some embodiments, δ may be taken from the considerably smaller experiments depicted in FIG. 22 to perform the analysis.

### Determination of Chain of Inverters Robustness

The preceding analysis that can be performed by statistical analysis/characterization determination component 500 and quantification component 502 employing noise margins and circuit robustness can be extended to arbitrary networks of inverters. In some embodiments, the probability of failure of a linear chain of n inverters can differ significantly from that of n cross-coupled inverters. In particular, a cross-coupled pair of identical inverters can be modeled as, and can be mathematically equivalent to, an infinite chain of identical inverters. Moreover, alternating worst-case noise sources between a cross-coupled pair can be modeled as alternating noise in an infinite chain, as depicted in FIG. 25. FIG. 25 illustrates an example of an infinite chain construct equivalent to the cross-coupled pair of FIG. 12 for determination of electronic circuit robustness in accordance with one or more embodiments described herein.

One idea behind this equivalence is that an infinite chain can be viewed as the unrolling of the loop that is a cross-coupled pair. When a bistable cross-coupled pair in steady state is perturbed by some voltage δV, the bistable pair may either change digital state, or the inverters may act as a restorative filter, successively removing the δV disturbance one iteration at a time in the same exact way that a chain of inverters may filter a δV disturbance. As used herein, δV means a change voltage of magnitude, dV. When the inverters are not identical, the two circuits may no longer behave in the same way, and equivalence can be lost.

Consider a cross-coupled inverter pair (INVₐ, INV_{b}), where INVₐ and INV_{b} may behave differently due to parameter variation. With the infinite chain construct, this pair can be modeled as a never-ending alternating linear chain of INVₐ driving INV_{b} driving INVₐ driving INV_{b}, etc. (see FIG. 15). Suppose that this inverter pair may not be robust, e.g., the static noise margin may be just slightly larger than 0 mV due to INVₐ being skewed such that INVₐ can barely interpret a logical-0 and INV_{b} being skewed such that INV_{b} can barely interpret a logical-1. Consider the state where the input of INVₐ is a logical-0 and its output (the input of INV_{b}) is a logical-1. A small DC noise can raise the input voltage, thus causing INVₐ to no longer interpret its input as a logical-0, thus resulting in a lowering of its output node voltage. This, in turn, can result in INV_{b} no longer interpreting its input as a logical-1, thus resulting in INV_{b} raising its output node voltage. This result, in turn, pushes INVₐ even further away from interpreting its input as a logical-0, and so on down the infinite chain until the bistable pair changes digital state.

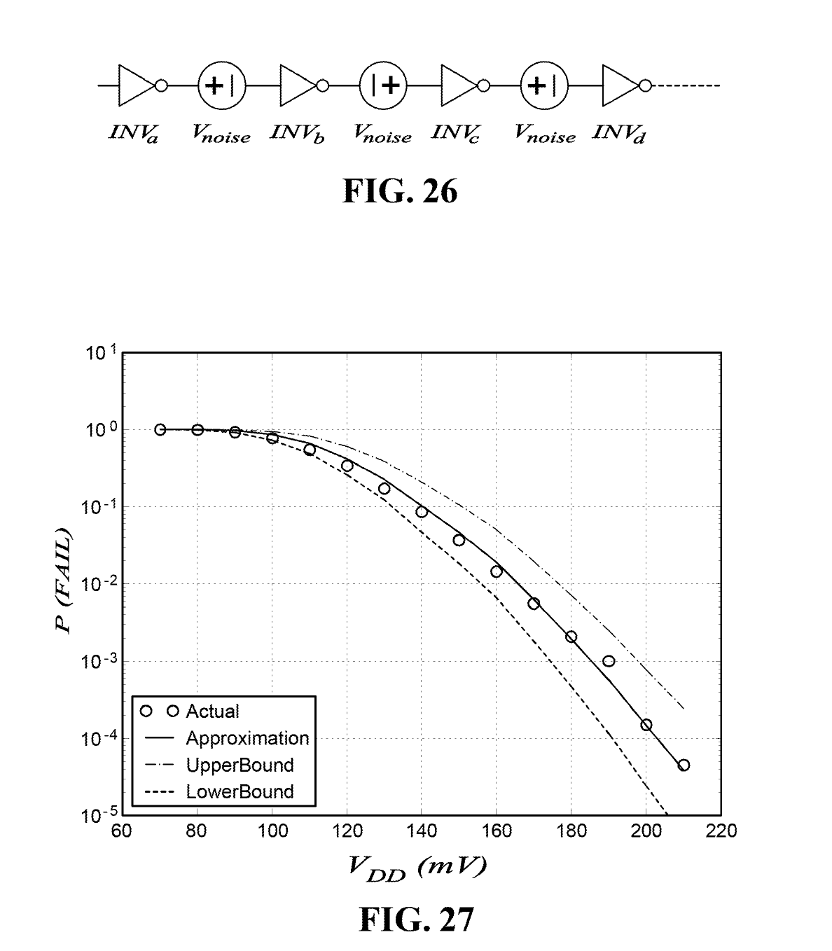

FIG. 26 illustrates an example of a chain of inverters for determination of electronic circuit robustness in accordance with one or more embodiments described herein. Consider an actual linear chain of inverters, as in FIG. 26. Due to parameter variation, each inverter in the chain may behave differently. Suppose that the chain begins with the identical sequence of skewed INVₐ driving a skewed INV_{b}, but INV_{b} now drives a different inverter INV_{c}. Again, consider the same state and event where the input of INVₐ is a logical-0 and its output (the input of INV_{b}) is a logical-1, and a small DC noise raises the input voltage, thus causing INVₐ to no longer interpret its input as a logical-0, resulting in a lowering of its output node voltage. This, in turn, results in INV_{b} no longer interpreting its input as a logical-1, resulting in INV_{b} raising output node voltage. Suppose, however, that INV_{c} is a robust inverter and completely restores the rather poor logical-0 generated by INV_{B} to approximately 0 mV. That is, the condition that causes INVₐ and INV_{b} to change state if configured as a cross-coupled pair may not cause a failure with INVₐ and INV_{b} in a linear chain.

In order to determine equations/methods for quantification component 502 to calculate the probability of failure for a chain of inverters, the notion of what it means for a chain to fail is defined. However, cross-coupled inverter static noise margin analysis may avoid the definition of failure of an individual inverter by considering a bistable loop. Analogously, consider a chain of an even number, n>2, of inverters. If the output of the last inverter in the chain is connected to the input of the first inverter, then the chain may become a state-holding ring (loop). The definition of failure naturally follows as a failure of the ring to maintain state. Informally, the requirement of an even number of stages may not result in a loss of generality, as it is possible to calculate a tight upper and lower bound on failure rate by considering a chain with one extra and one fewer inverters respectively.

As with the cross-coupled inverter pair analysis, the NM_{H} and NM_{L} can be used to generate an upper bound, a lower bound, and an approximation for the probability of failure for chains of inverters. For a chain of inverters, the worst-case, demonic, DC noise can include alternating positive and negative voltage sources acting contrary to the desired state of each inverter input. That is, if the desired input to a gate is logical-1, e.g., V_{DD}, then a voltage source that acts to lower this electrical potential may be said to act contrary to the desired state. In steady-state, a linear chain of n functional inverters may include alternating sequences of 0 and 1 at the input of each inverter. As such, there may be two possible digital states for such a chain: the sequence either begins with a 1 or it begins with a 0. Correspondingly, there may be two states for alternating demonic noise sources; the first DC noise source may be either positive or negative.

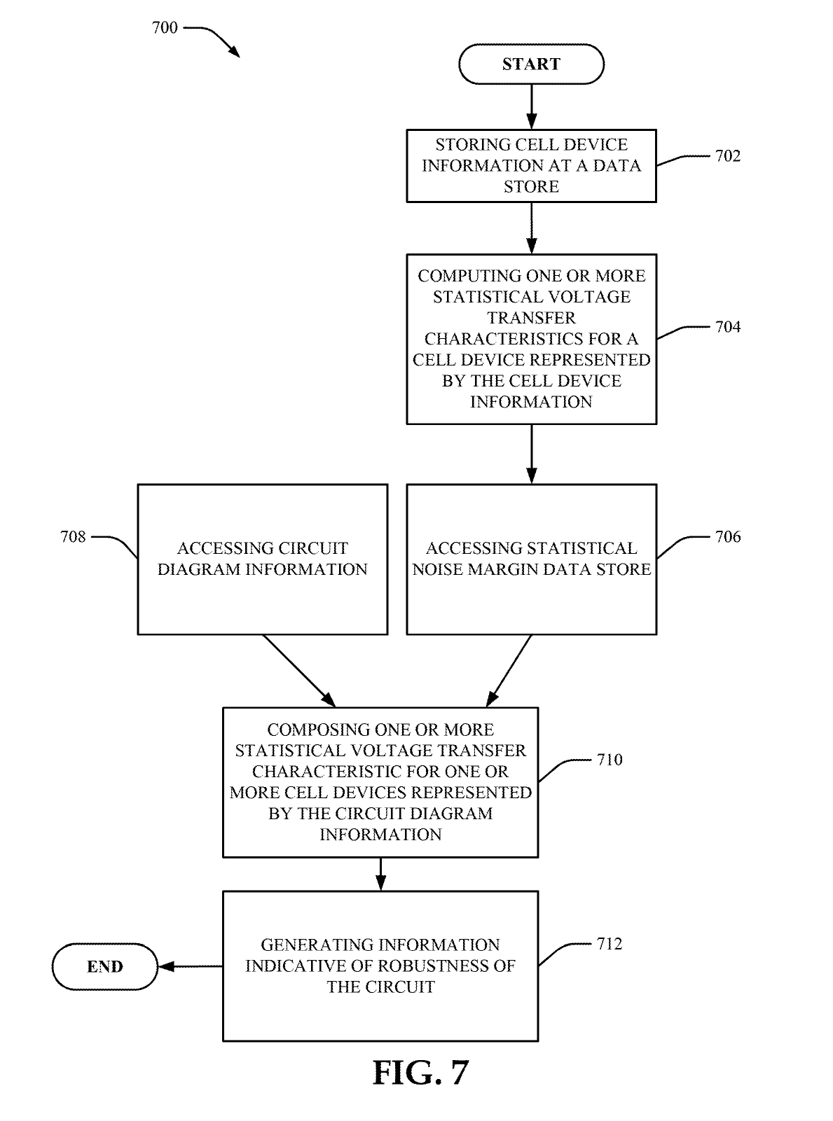

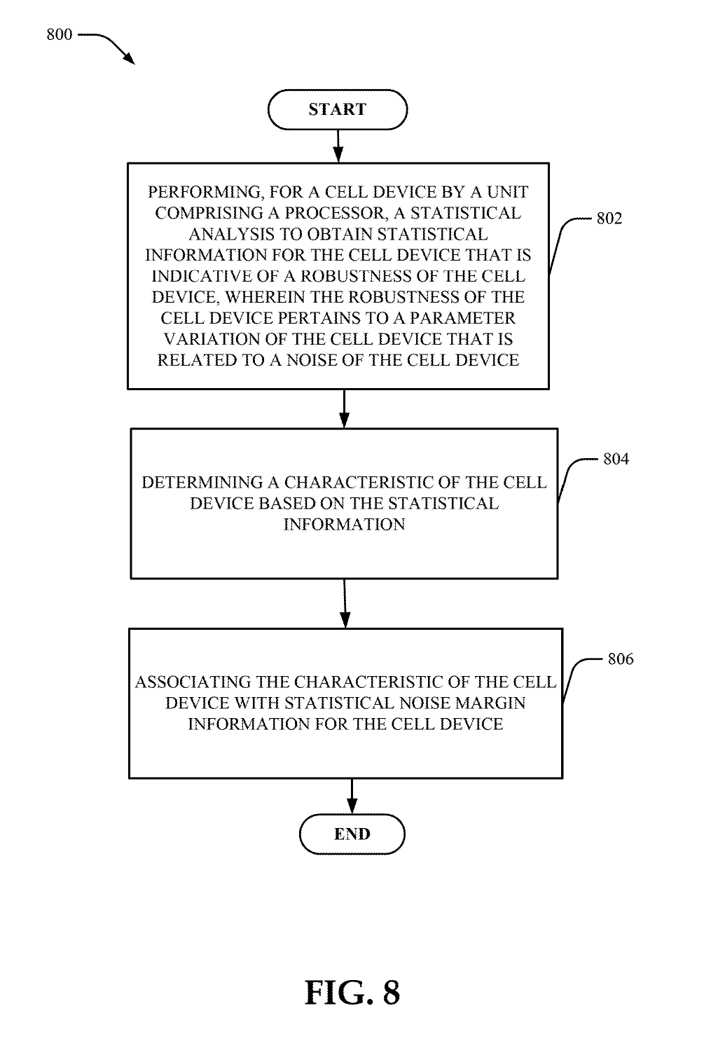

Consider a linear chain, CHₐ, of n inverters with demonic noise sources, as in FIG. 26 (with the constraint that n is an even integer greater than 2). The chain may be said to fail if the corresponding ring, created by connecting the output of the last inverter to the input of the first inverter, fails to maintain state when all inverter inputs are properly initialized with alternating values of 0 and 1. The chain and ring may fail with respect to a noise margin target, NM_{T}, when the ring fails to maintain state with demonic noise sources with Vₙₒᵢₛₑ=NM_{T} or Vₙₒᵢₛₑ=−NM_{T}. Given the assumption of statistical independence between the noise margins of different gates pairs (as discussed with reference to FIGS. 7 and 8), the probability of chain failure can be analyzed and computed in terms of the NM_{H} and NM_{L} of pairs of gates.

A heuristic upper bound can be determined as follows. Consider a labeling of inverters in the chain CHₐ such that the first inverter is labeled as INV₁, the second inverter as INV₂, and so on with the last inverter being INVₙ. If the chain fails, then it follows that there may exist some inverter pair in the chain, INVᵢ driving INVᵢ₊₁, with NM_{H}(INVᵢ, INVᵢ₊₁)≦NM_{T} and/or NM_{L}(INVᵢ, INVᵢ₊₁)≦NM_{T}, which leads to the same probabilistic upper bound for cross-coupled pairs. For chains, however, this may not not be a tight upper bound. Empirically, the cross-coupled pair heuristic approximation can lead to a tighter upper bound for chains of gates.

Consider two connected pairs of inverters, the set (INVᵢ, INVᵢ₊₁, INVᵢ₊₂); if the chain fails, then it may be likely that either (1) NM_{L}(INVᵢ, INVᵢ₊₁)≦NM_{T} and NM_{H}(INV₁₊₁, INVᵢ₊₂)≦NM_{T}), and/or (2) NM_{H}(INVᵢ, INVᵢ₊₁)≦NM_{T}) and NM_{L}(INVᵢ₊₁, INVᵢ₊₂)≦NM_{T}). With the assumption of statistical independence, the upper bound on the probability of failure for the chain can be approximated as shown in Equation 21 below:

P(FAIL(CHₐ,NM_{T})≦P(U_{iΣ{1,2, . . . ,n-2}}((NM_{H}(INVᵢ,INVᵢ₊₁)≦NM_{T}+δu∩NM_{L}(INVᵢ₊₁,INVᵢ₋₂)≦NM_{T}+δu)∪(NM_{L}(INVᵢ,INVᵢ₊₁)≦NM_{T}+δu·NM_{H}(INVᵢ₊₁,INVᵢ₊₂)≦NM_{T}+δu))) (Equation 21).

In Equation 21, δu is a small constant used to maintain the boundary over a wide range of NM_{T} and V_{DD}. Sample values for δu are typically on the order of +−2%.

A heuristic for the lower bound may have the same form, but a small constant δl may be subtracted from the NM_{T} and is shown in Equation 22 below:

P(FAIL(CHₐ,NM_{T})≧P(U_{iΣ{1,2, . . . n-2}}((NM_{H}(INVᵢ,INVᵢ₊₁)≦NM_{T}−δl∩NM_{L}(INVᵢ₊₁,INVᵢ₋₂)≦NM_{T}−δl)∪(NM_{L}(INVᵢ,INVᵢ₊₁)≦NM_{T}−δl∩NM_{H}(INVᵢ₊₁,INVᵢ₊₂)≦NM_{T}−δl))) (Equation 22).

The value for δl is typically +=2%. The heuristic approximation may follow from the upper and lower bound heuristics. In particular, Equation 23 results and is shown below:

P(FAIL(CHₐ,NM_{T})≈P(U_{iΣ{1,2, . . . ,n-2}}((NM_{H}(INVᵢ,INVᵢ₊₁)≦NM_{T}+δ∩NM_{L}(INVᵢ₊₁,INVᵢ₋₂)≦NM_{T}+δ)∪(NM_{L}(INVᵢ,INVᵢ₊₁)≦NM_{T}+δ∩NM_{H}(INVᵢ₊₁,INVᵢ₊₂)≦NM_{T}+δ))) (Equation 23).

Empirically, δu and δl can be defined in terms of δ. For the devices: INV, NAND2, NOR3, NAND3, NOR3, AOI21, each of which may be static CMOS gates, and for noise margin targets between 0% V_{DD} and 20% V_{DD}, a relative offset of 3% V_{DD} may be sufficient. That is, δu=δl=δ+3% V_{DD}.

FIGS. 27, 28, 29, 30, 31 illustrate example graphs depicting probabilities of failure for minimum-size inverters in chains for determination of electronic circuit robustness in accordance with one or more embodiments described herein. In particular, FIGS. 27, 28, and 29 depict the upper bound, lower bound, and approximations for a chain of 20 inverters.

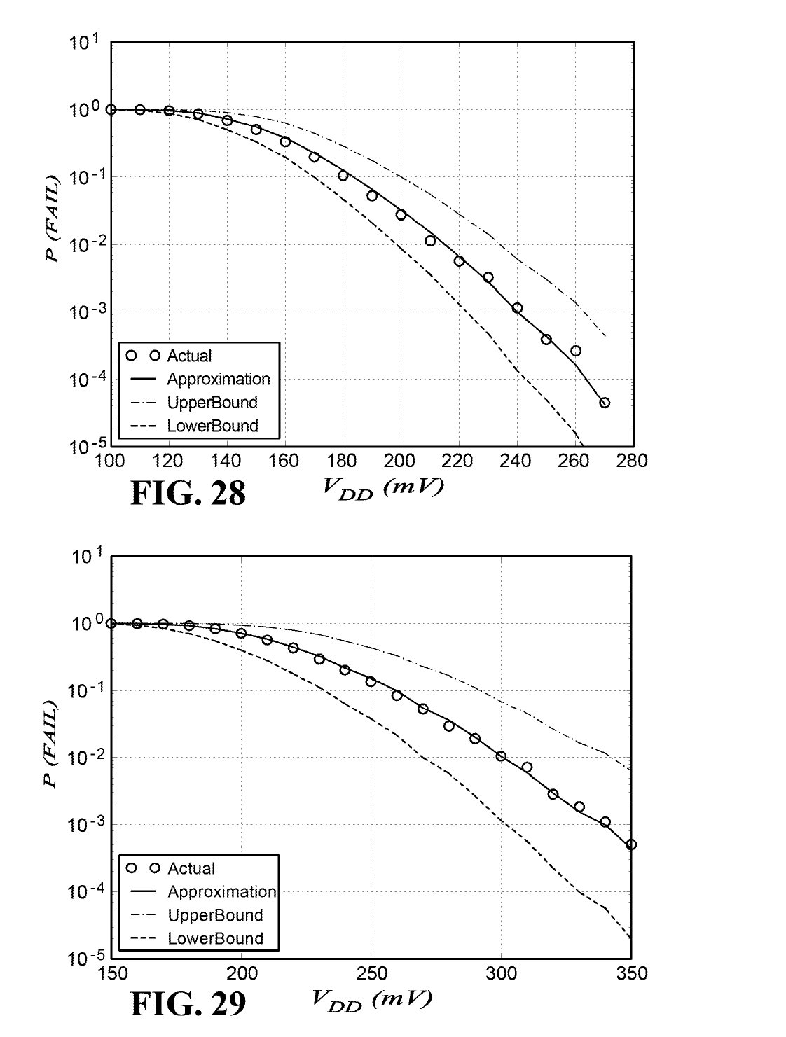

FIG. 27 illustrates an example probability of a chain of 20 inverters failing with NM_{T}=0% V_{DD} in a commercial 40 nm low-power CMOS process (25° C., TT-Corner). For the heuristic approximation, the mean absolute error may be 17%, and the maximum absolute error may be 43% with δ=−3.2% V_{DD}. FIG. 28 illustrates an example probability of a chain of 20 inverters failing with NM_{T}=10% in a commercial 40 nm low-power CMOS process (25° C., TT-Corner). For the heuristic approximation, the mean absolute error may be 13%, and the maximum absolute error may be 38% with δ=−2.3% V_{DD}. FIG. 29 illustrates an example probability of a chain of 20 inverters failing with NM_{T}=20% in a commercial 40 nm low-power CMOS process (25° C., TT-Corner). For the heuristic approximation, the mean absolute error may be 6.8%, and the maximum absolute error may be 24% with δ=−1.8% V_{DD}.

A circuit, Cₐ, composed of n chains of inverters, may be said to fail if any chain fails. That is, with chain labeled as CH₁, CH₂, . . . , CHₙ, Equation 24 results and is shown below.

P(FAIL(CHₐ,NM_{T})=P(U_{iΣ{1,2, . . . ,n}}(FAIL(CHᵢ,NM_{T})) (Equation 24).

As with the cross-coupled inverter analysis, Equation 24 can be re-written in terms of a global conjunction instead of disjunction as shown in Equation 25:

P(FAIL(CHₐ,NM_{T})=1−P(∩_{iΣ{1,2, . . . ,n}}−FAIL(CHᵢ,NM_{T})) (Equation 25).

Given the assumption of statistical VTC parameter independence between gate pairs, and hence chains, the global conjunction can be treated as a product, giving a readily computable compact expression for the probability of failure and hence robustness of a circuit having chains of inverters. For example, Equation 26 results and is shown below:

P(FAIL(CHₐ,NM_{T})=1−P(Π_{iΣ{1,2, . . . ,n}}−FAIL(CHᵢ,NM_{T})) (Equation 26).

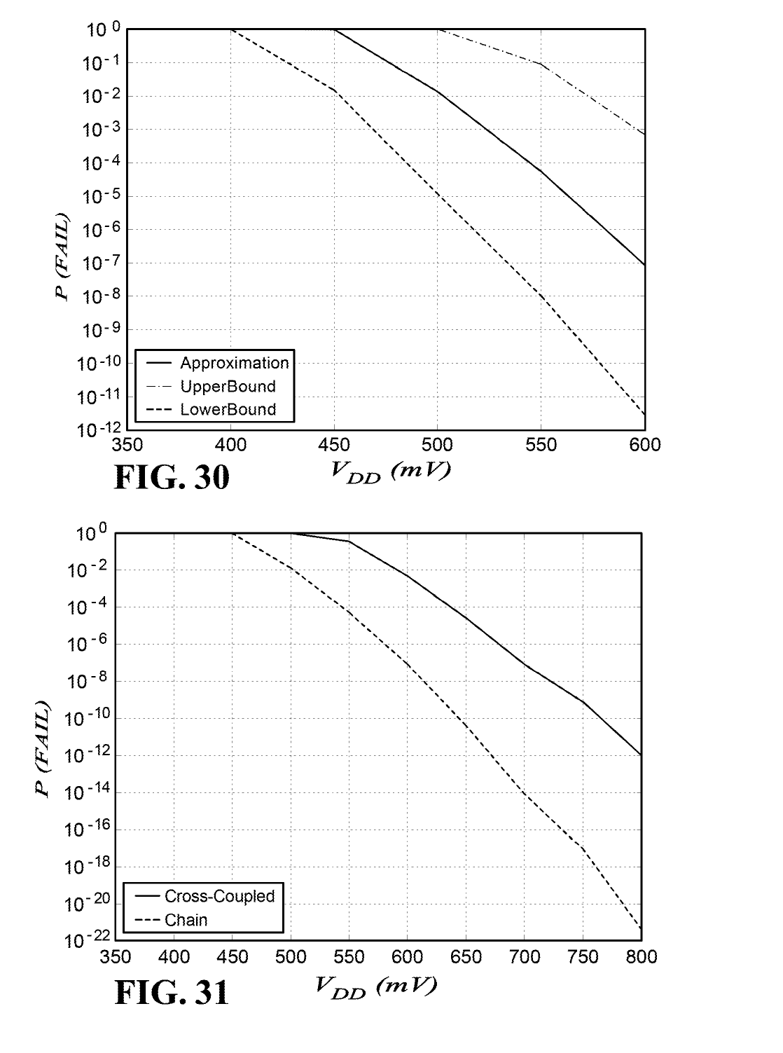

FIG. 30 illustrates an example probability of failure for 2*2e²⁸ minimum-size inverters in chains with NM_{T}=20% V_{DD} in a commercial 40 nm low-power CMOS process (25° C., TT-Corner, and δ=−1.8% V_{DD}). FIG. 31 illustrates an example probability of failure for 2*2e²⁸ minimum-size inverters in chains compared to that of 2e²⁸ minimum size cross-coupled pairs with NM_{T}=20% V_{DD} in a commercial 40 nm low-power CMOS process (25° C., TT-Corner). As used herein, 2*2e²⁸ means 2 multiplied by 2 e²⁸.

Quantification component 502 can perform methods to compute a value for robustness for a chain of inverters based on applying Equation 26. FIG. 30 gives an example of the probability of failure for 2*2e²⁸ independent inverters in the form of chains. δ may be based on what is depicted in FIG. 29. In the drawing shown, δ is a fitting constant determined by analysis smaller sample size 20-chains (instead of 2e28 chains).

The probability of failure of chains of inverters may be considerably lower than that of cross-coupled pairs (with the same number of devices, noise-margin target, and V_{DD}), as depicted in FIG. 31. The failure probabilities may be similar for cross-coupled pairs of inverters operating 50-100 mV above the inverter chain supply voltage.

The analysis described above for a chain of inverters and cross-coupled inverter pairs can be extended to a larger gate set than that of inverters alone. Employing the following methods, quantification component 502 can generate a composable robustness metric for a wide variety of gates so that the robustness of an arbitrary network of standard cell devices can be easily computed.

### Robustness of Logic Gates

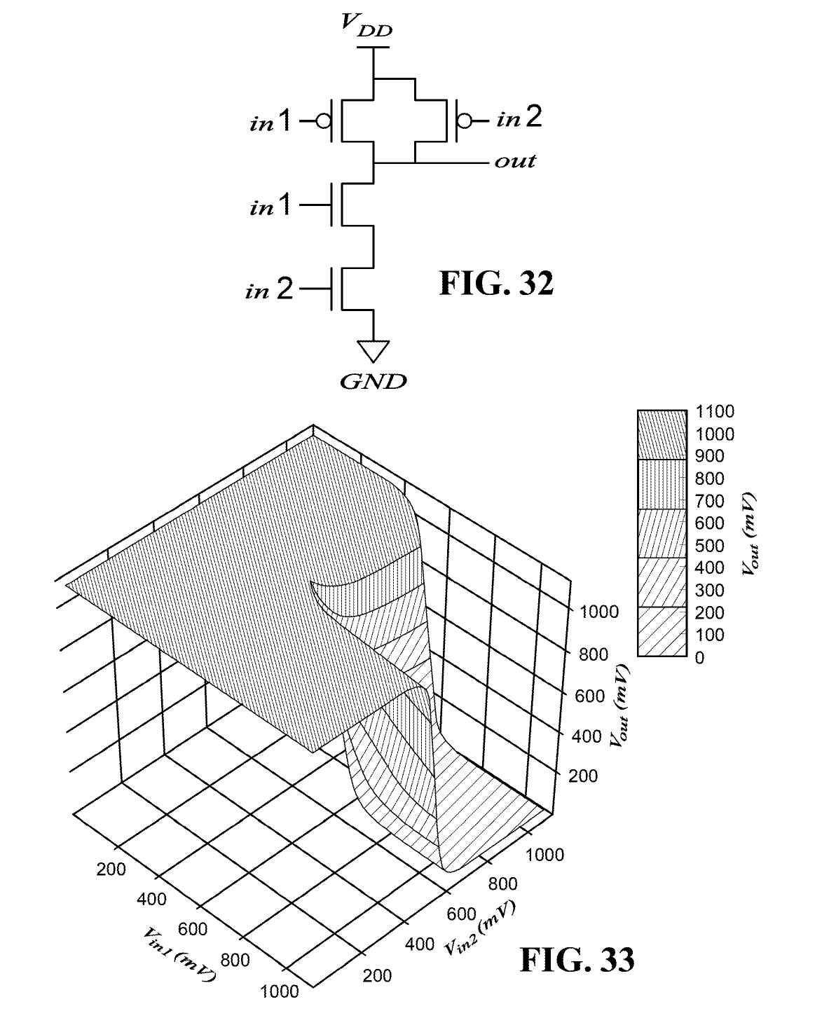

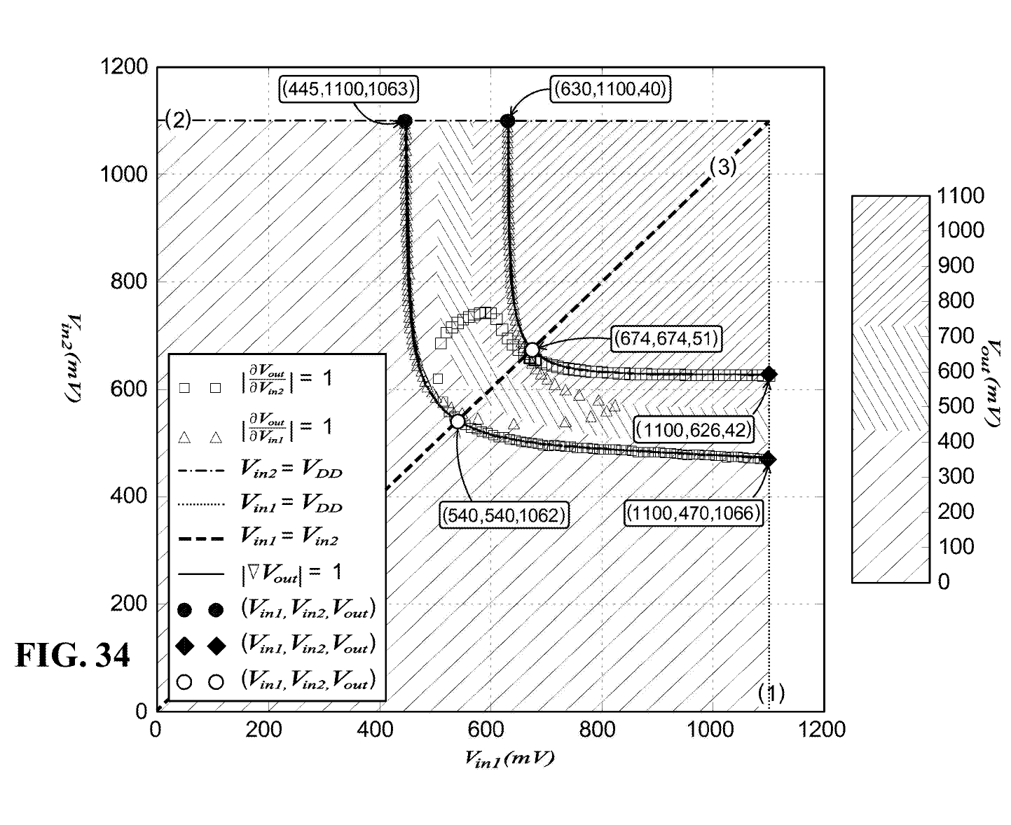

FIG. 32 illustrates an example NAND2 circuit diagram for determination of electronic circuit robustness in accordance with one or more embodiments described herein. FIGS. 33 and 34 illustrate example graphs of VTCs for the minimum-size NAND2 for determination of electronic circuit robustness in accordance with one or more embodiments described herein.

Specifically, FIG. 32 illustrates an example of a NAND2 device, and FIG. 33 illustrates example voltage transfer characteristic for the minimum-size NAND2 depicted in FIG. 32, in a commercial 40 nm low-power CMOS process (V_{DD}=1.1V, 25° C., TT-Corner). FIG. 34 illustrates example voltage transfer characteristic for the minimum-size NAND2 depicted in FIG. 32 in a commercial 40 nm low-power CMOS process (V_{DD}=1.1V, 25° C., TT-Corner).

The term “NAND2” can represent a combinational CMOS 2-input NAND gate with nodes labeled as shown in FIG. 32. If the input nodes, in1 and in2, are treated independently, then the statistical VTC may describe Vₒᵤₜ as a function of both Vᵢₙ₁ and Vᵢₙ₂ as depicted in FIGS. 33 and 34. FIGS. 33 and 34 illustrate example graphs of VTCs for the minimum-size NAND2 for determination of electronic circuit robustness in accordance with one or more embodiments described herein, and more specifically, FIG. 33 provides a three dimensional view and, FIG. 34 plots the statistical VTC in the Vᵢₙ₁×Vᵢₙ₂ plane with Vₒᵤₜ encoded by hatching. The partial derivatives

$$\frac{\partial {V}_{out}}{\partial {V}_{in 1}} and \frac{\partial {V}_{out}}{\partial {V}_{in 2}}$$

may describe two continuums of unity gain points depicted by triangles and squares, respectively, in FIG. 34.

The gradient is given by Equation 27 below:

$$∇ {V}_{out} = \frac{\partial {V}_{out}}{\partial {V}_{in 1}} i + \frac{\partial {V}_{out}}{\partial {V}_{in 2}} j , \qquad ( Equation 27 )$$

where i and j are the unit vectors in the Vᵢₙ₁×Vᵢₙ₂ plane. The two continuums of unity gain points defined by |∇Vₒᵤₜ|=1 (depicted by a black line in FIG. 34) may be analogous to an inverter's two unity gain points given by

$$\vert \frac{d {V}_{out}}{d {V}_{in}} \vert = 1$$

above for the cross-coupled inverter pair. For an inverter, the two measures can be identical:

$$\vert ∇ {V}_{out} \vert ≡ \vert \frac{d {V}_{out}}{d {V}_{in}} \vert .$$

Moreover, the magnitude of ∇Vₒᵤₜ may be the most general measure for determining unity gain points, as it may be applicable to any gate regardless of the number of inputs. For noise margin analysis, choosing individual unity gain points as representative approximations can be provided, and individual points can be chosen by considering slices of the statistical VTC (planes orthogonal to Vᵢₙ₁×Vᵢₙ₂). Three slices of the NAND2 statistical VTC are depicted by dashed lines in FIG. 34. These three slices may be notable for two reasons. First, they may give the upper and lower unity-gain bounds in terms of Vᵢₙ₁ and Vᵢₙ₂ Second, they may correspond to a logical reduction of the NAND2 to that of an inverter. That is, if either input is tied to logical-1 or if both inputs are tied together, then the NAND2 may be functionally equivalent to an inverter.

In FIG. 34, the three possible inverter-equivalent slices are depicted by: (1) a first dashed line along the rightmost edge of the graph labeled (1) and corresponding to tying in1 to V_{DD} and sweeping in2 from GND to V_{DD}; a second dashed line along the top edge of the graph labeled (2) and corresponding to tying in2 to V_{DD} and sweeping in1 from GND to V_{DD}; and a third dashed line running diagonal from the upper right corner of the graph to the lower left corner of the graph labeled (3) and generated by tying in1 to in2 and sweeping them together.

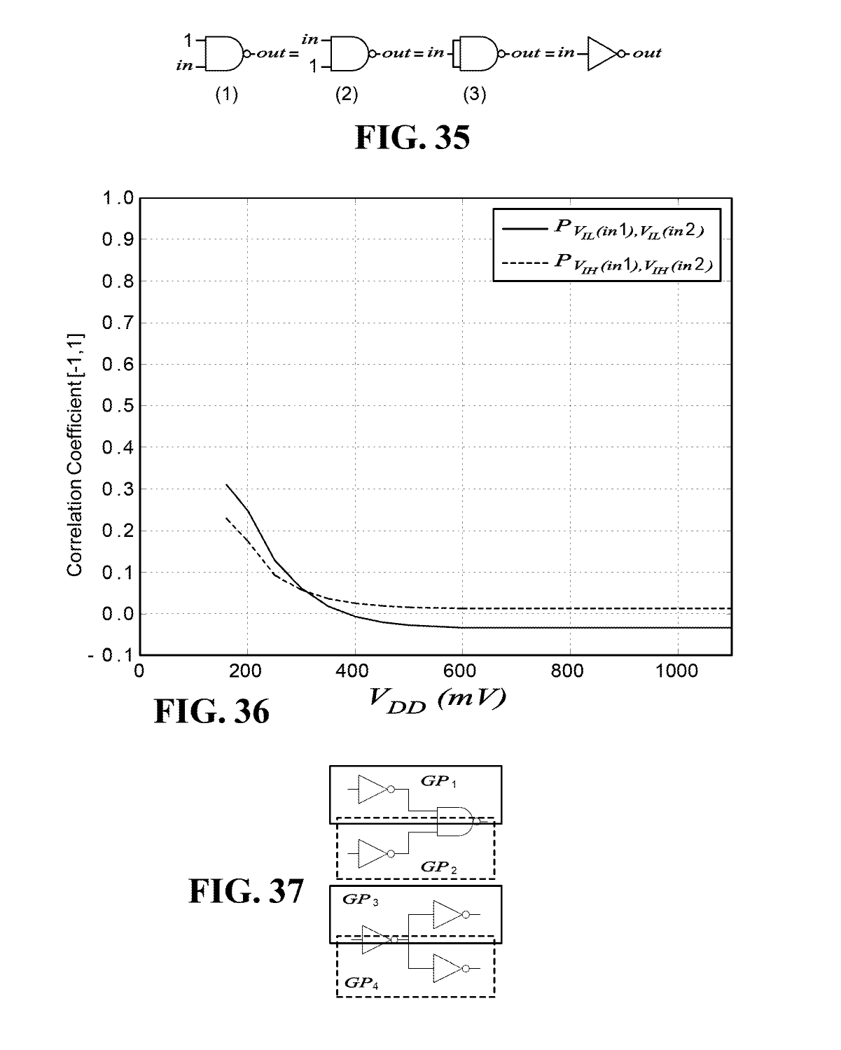

FIG. 35 illustrates an example circuit diagram of NAND2 inverter equivalence for determination of electronic circuit robustness in accordance with one or more embodiments described herein. The idea of inverter-equivalence can be used to generate the boundary unity-gain points for arbitrary gates. Consider an inverting binary CMOS gate, G, with n inputs and a single output. Gate G can be made to act logically as a single input/output inverter for some assignment of inputs where inputs can be tied together, tied to 1, or tied to 0. Since G may be an inverting CMOS gate, one or more inverter-equivalent input assignments may exist, and the assignments may depend on the topology of G. The three inverter-equivalent slices from FIG. 34 are depicted at the gate level in FIG. 35.

A general notion of an inverter equivalent assignment is helpful. Let G be an inverting binary CMOS gate with k inputs labeled as in1, in2, . . . , ink, a single output, out, and with functionality defined by Vₒᵤₜ=G(Vᵢₙ₁, Vᵢₙ₂, . . . , Vᵢₙₖ). The set of inverter equivalent input assignments to G, denoted IE(G), may be a set of k-tuples, (ie₁, ie₂, . . . , ieₖ), where ieε(1, 0, in) and (ie₁, ie₂, . . . , ieₖ)εIE(G) if and only if G(ie₁, ie₂, . . . , ieₖ) is functionally equivalent to an inverter with input in, and output out. For the NAND2, the three inverter equivalent input assignments may be (1) (1, in), (2) (in, 1) and (3) (in, in). In order to work with inverter equivalent input assignments, it may be convenient to define F, a simple mapping function between real voltages and elements of (1, 0, in). That is, the following relationships may result: F(Vᵢ)=0, if Vᵢ=GND; F(Vᵢ)=1, if Vᵢ=V_{DD}; F(Vᵢ)=in, otherwise.

With a notion of inverter equivalence, it is possible to define a representative set of unity gain points for a gate. Let G be an inverting binary CMOS gate with k inputs labeled as in1, in2, . . . , ink, and a single output, out. The gradient of Vₒᵤₜ is defined as shown in Equation 29:

$$∇ {V}_{out} = \frac{\partial {V}_{out}}{\partial {V}_{in 1}} i + \frac{\partial {V}_{out}}{\partial {V}_{in 2}} {i}_{2} + … + \frac{\partial {V}_{out}}{\partial {V}_{ink}} {i}_{k} , \qquad ( Equation 20 )$$

where i₁, i₂, . . . , iₖ are the corresponding unit vectors. The representative set of unity gain points for G, RS (G), is defined such that Equations 30 and 31 result and are shown below:

(Vᵢₙ₁,Vᵢₙ₂, . . . ,Vᵢₙₖ,Vₒᵤₜ)εRS(G) if and only if |∇Vₒᵤₜ(Vᵢₙ₁,Vᵢₙ₂, . . . ,Vᵢₙₖ)|=1, and

(F(Vᵢₙ₁),F(Vᵢₙ₂)), . . . ,F(Vᵢₙₖ))εIE(G), and for all x,yε(1,2, . . . ,k) (Equation 30)

if F(Vᵢₙₓ)=and F(V_{iny})=then Vᵢₙₓ=V_{iny}. (Equation 31).

For the NAND2, the representative set of unity gain points are depicted in FIG. 34 as shaded circles, shaded diamonds and unshaded circles with annotated values. The values for each slice (Vᵢₙ₁,Vᵢₙ₂,Vₒᵤₜ) may be (1): (1100,470,1066), (1100,626,42) (2): (445,1100,1063), (630,1100,40), (3): (540,540,1062), (674,674,51). These representative points can be mapped back to simple pairs of the form (Vᵢₙ,Vₒᵤₜ) by using the inverter equivalent input assignment to remove the references to V_{DD}, GND, and shared inputs. For the NAND2, this reduced representative set of unity gain points may be (1): (470,1066), (626,42) (2): (445,1063), (630,40), (3): (540,1062), (674,51).

The statistical VTC parameters can be defined using the reduced set of unity gain points. The usual mapping of unity gain points to statistical VTC parameters can be employed, so for the NAND2, (1): V_{IL}=470, V_{OH}=1066, V_{IH}=626, V_{OL}=42, (2): V_{IL}=445, V_{OH}=1063, V_{IH}=630, V_{OL}=40, and (3): V_{IL}=540, V_{OH}=1062, V_{OH}=674, V_{OL}=51. Statistical analysis may be greatly simplified when a single set of representative statistical VTC parameters is chosen, but the parameters—as measured with (1), (2), and (3)—may differ. V_{OH} and V_{OL} may be nearly constant. The two inverter equivalent input assignments where a single input is tied to V_{DD} ((1) and (2)) may be highly symmetric and may have only slightly different values for V_{IH} and V_{IL}, respectively. The input assignment wherein both inputs are tied together, (3), may differ significantly in terms of V_{IH} and V_{IL} from (1) and (2).

Consider the measurement of V_{IL} performed by sweeping the input(s) from GND to V_{DD} using (1) as compared to (3). The value of V_{IL} may correspond to the greatest input voltage that still results in the output being pulled-up to a logical-1. The NAND2 may contain 2 parallel PFETs with gates connected to in1 and in2, respectively. With input assignment (1), in1 is tied to V_{DD}, causing the corresponding PFET to effectively turn off, e.g., it contributes only sub-threshold leakage current to the pull-up network as in2 is swept from GND to V_{DD}. As Vᵢₙ₂ is increased, the corresponding PFET begins to turn off and the NFETs begin to turn on, thus transitioning the output towards a logic-0; V_{IL} is the input voltage at which this transition occurs. With (3), both inputs are tied together, and the parallel PFETs actively pull up the output node together as the input is swept. The parallel PFETs in (3) continue to actively pull up the output node as the input voltage is increased beyond the V_{IL} from (1). As such, V_{IL} as measured with (3) is greater than V_{IL} as measured with (1). An analogous, but reciprocal explanation can be given for V_{IH}. That is, V_{IH} as measured with (1) is greater than V_{IH} as measured with (3).

In order to provide an upper bound on the robustness, the representative set of statistical VTC parameters may be chosen so as to overestimate the probability of failure of a gate. This corresponds to underestimating both NM_{H} and NM_{L}; this, in turn, may involve underestimating V_{IH} and overestimating V_{IL} assuming that the corresponding variances are approximately equal.

Since V_{OH} and V_{OL} may be approximately constant across inverter equivalent input assignment slices, the smallest V_{IH} and the largest V_{IL} may be chosen from the reduced representative set of unity gain points. For the NAND2, this may correspond to selecting the statistical VTC parameters from different slices: V_{IH} from (1) and V_{IL} from (3). In a similar manner, the smallest V_{OH} and largest V_{OL} could be chosen as representative statistical VTC parameters; however, the output statistical VTC parameters may be approximately constant, so they can also be chosen arbitrarily or by convenience.

In the embodiments described herein, the statistical VTC parameters from (1) may be chosen as the representative set, despite the fact that this simplifying choice slightly underestimates V_{IL}. In terms of calculating the probability of failure, this simplification has little impact.

The statistical VTC parameters for an arbitrary gate can be defined. Let G be an inverting binary CMOS gate with m inputs and a single output, out, and let RS(G) be the reduced representative set of unity gain points for G. Assume that RS(G) has cardinality n, and elements labeled as (Vᵢₙ_{ᵢ},Vₒᵤₜ_{ᵢ}) for iε{1, 2, . . . , n}. The statistical VTC parameters for G may be defined as (G)=min(Vᵢₙ_{ᵢ})(G)=max(Vᵢₙ_{ⱼ})(G)=min(Vₒᵤₜ_{ₖ})(G)=max(Vₒᵤₜ_{ₗ}), for i, j, k, lε{1, 2, . . . , n}.

To provide general definitions for NM_{H} and NM_{L}, the input statistical VTC parameter correlation between multiple inputs of the same gate may be considered. FIG. 36 illustrates an example graph of NAND2 input correlation for determination of electronic circuit robustness in accordance with one or more embodiments described herein. FIG. 36 illustrates an example NAND2 input correlation in a commercial 40 nm low-power CMOS process (V_{DD}=1.1V, 25° C., TT-Corner).

As shown in FIG. 36, the input statistical VTC parameters may be highly uncorrelated over a wide range of V_{DD}. Given this and the treatment of output statistical VTC parameters as regular variables, arbitrary networks of combinational gates with fan-in and fan-out greater than unity can be broken apart into equivalent gate-pairs, and ultimately, into inverter-equivalent pairs for statistical analysis; e.g., for the purpose of computing the probability of circuit failure.

FIG. 37 illustrates an example circuit diagram detailing equivalent gate pairs formed from multiple fan-in and fan-out gate networks for determination of electronic circuit robustness in accordance with one or more embodiments described herein. Gate pairs GP₁ and GP₂ may be formed for each input of the NAND gate, and gate pairs GP₃ and GP₄ may be due to the inverter fan-out.

Consider a circuit, Cₐ, that includes a network of n combinational gates in an array of simple linear chains; Cₐ may be said to fail if any chain of gates within the circuit fails (see Equation 24). In general, digital circuits include networks of combinational gates organized as interconnecting chains, wherein some gates drive multiple gates, some gates may be driven by multiple gates, or both. Consider a circuit, C_{b}, that includes a network of n combinational gates with interconnecting chains, e.g., some gates within C_{b} may drive multiple gates and some gates may have multiple inputs. Consider a gate, GₓεC_{b} that drives k gates in C_{b}, labeled as G₁, G₂, . . . , Gₖ. Since the output statistical VTC parameters of Gₓ may not be stochastic in nature, these gates can be treated as k equivalent gate-pairs (Gₓ,Gᵢ) for iε{1, 2, . . . , k}. As an example, consider GP₃ and GP₄ in FIG. 37. Similarly, consider k gates in C_{b}, labeled as G₃, G₄, . . . , Gₖ that drive (fan-in) to a multi-input gate, GₓεG_{b}.

Given that the input statistical VTC parameters of Gₓ may be independent, each pair, (Gᵢ, Gₓ) for iε{1, 2, . . . , k}, can be considered as components of independent equivalent gate-pairs, as illustrated in FIG. 37 by GP, and GP₂. As discussed above, equivalent gate-pairs can be analyzed as inverter equivalent pairs, and the robustness of a circuit having arbitrary connections of combinational gates can be computed by way of the methods described herein.

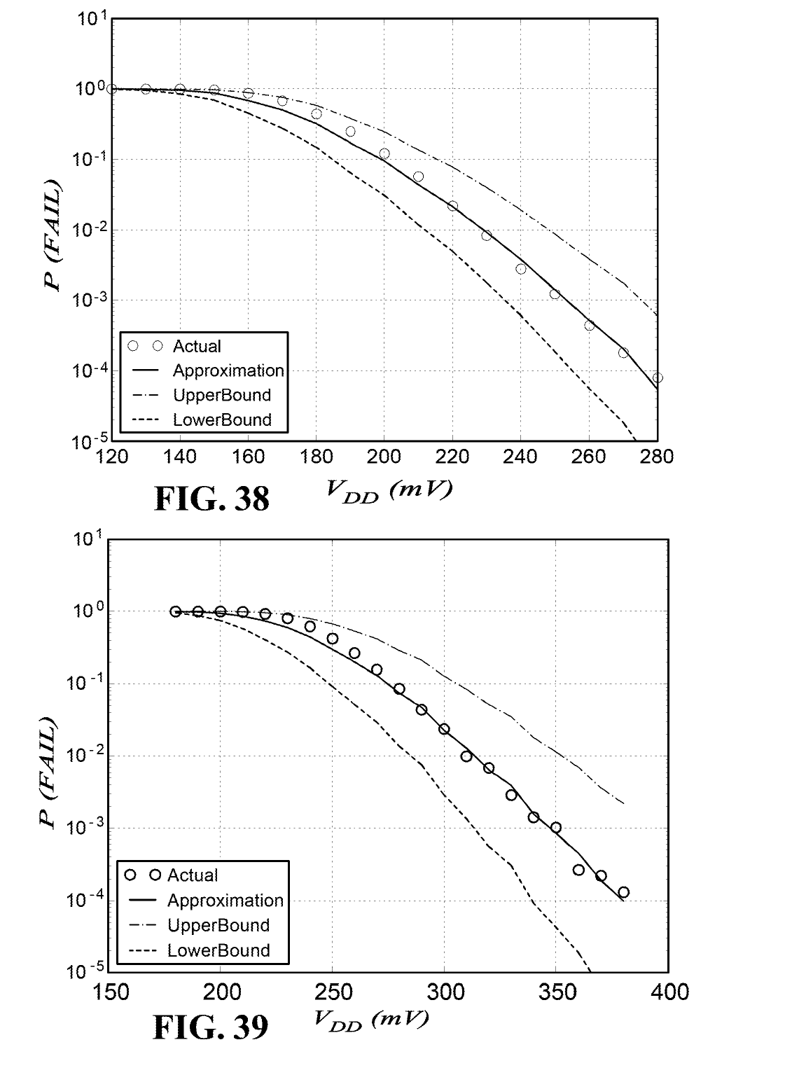

FIGS. 38 and 39 illustrate example graphs depicting probabilities of a chain of 20 alternating NAND2 and NOR2 gates failing for respective noise margin thresholds for determination of electronic circuit robustness in accordance with one or more embodiments described herein. FIG. 38 illustrates an example probability of a chain of 20 combinational gates failing (the chain includes alternating NAND2, NOR2 gates) with NM_{T}=10% V_{DD} in a commercial 40 nm low-power CMOS process (25° C., TT-Corner). For the heuristic approximation, the mean absolute error may be 16%, and the maximum absolute error may be 36% with ε=−1.2% V_{DD}. FIG. 39 shows an example of the probability of a chain of 20 combinational gates failing (the chain includes alternating NAND3, NOR3 gates) with NM_{T}=20% V_{DD} in a commercial 40 nm low-power CMOS process (25 C, TT-Corner). For the heuristic approximation, the mean absolute error may be 16%, and the maximum absolute error may be 67% with δ=−1.3% V_{DD}.

Accordingly, the embodiments described herein can facilitate determination of robustness for one or more different types of cell devices (and corresponding circuits composed from the one or more cell devices). For example, the cell devices can include, but are not limited to, inverters and gates. That is, for some circuit, Cₐ, and a target noise margin, NM_{T}, Equation 26 gives the probability that some gate chain in Cₐ may have a noise margin less than the target, e.g., a probability of failure, P(FAIL). This quantity can instead be considered as a passing probability P(PASS) by subtracting it from unity, and this passing probability can be thought of as a parametric yield.

Prediction component 404 of FIG. 4 can be configured to determine a yield of a parameter, or parametric yield. That is, prediction component 404 can determine the probability of passing (as opposed to failure) for a defined cell device (and correspondingly, for a defined circuit that includes one or more cell devices for which parametric yield has been determined by prediction component 404). In some embodiments, for example, if P(PASS)=95%, then in 95% of instances of Cₐ, all gates may exceed the noise margin target constraint (this is definitionally a parametric yield). If the circuit under consideration, Cₐ, is an entire microprocessor, then this parametric yield can be included as a part of the die yield calculation.

In Equation 26, the circuit under consideration, Cₐ, may be an independent variable, and P(FAIL) may be a dependent variable. The circuit Cₐ may instead be treated as dependent on P(FAIL). In this way, circuit design component 406 can calculate a maximum number of gates that can satisfy a defined constraint for a circuit (e.g., how large a circuit can be built). For example, for a defined NM_{T} and a yield, circuit design component 406 can calculate a maximum number of gates for the circuit.

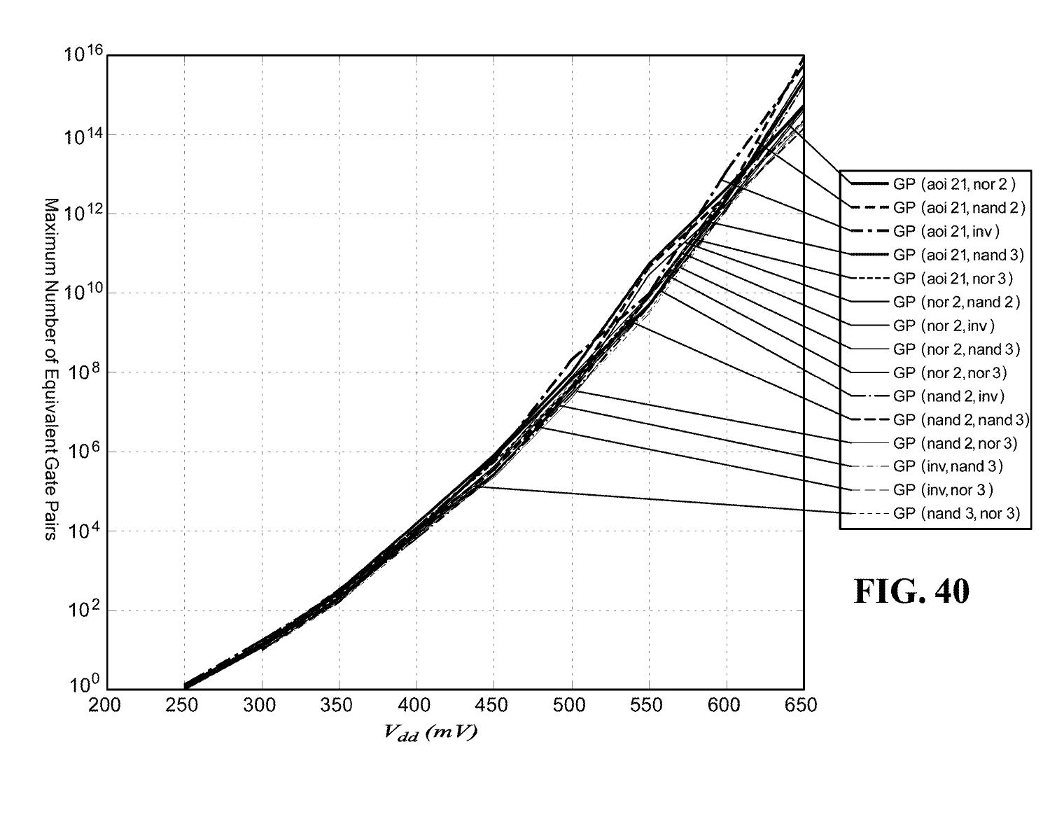

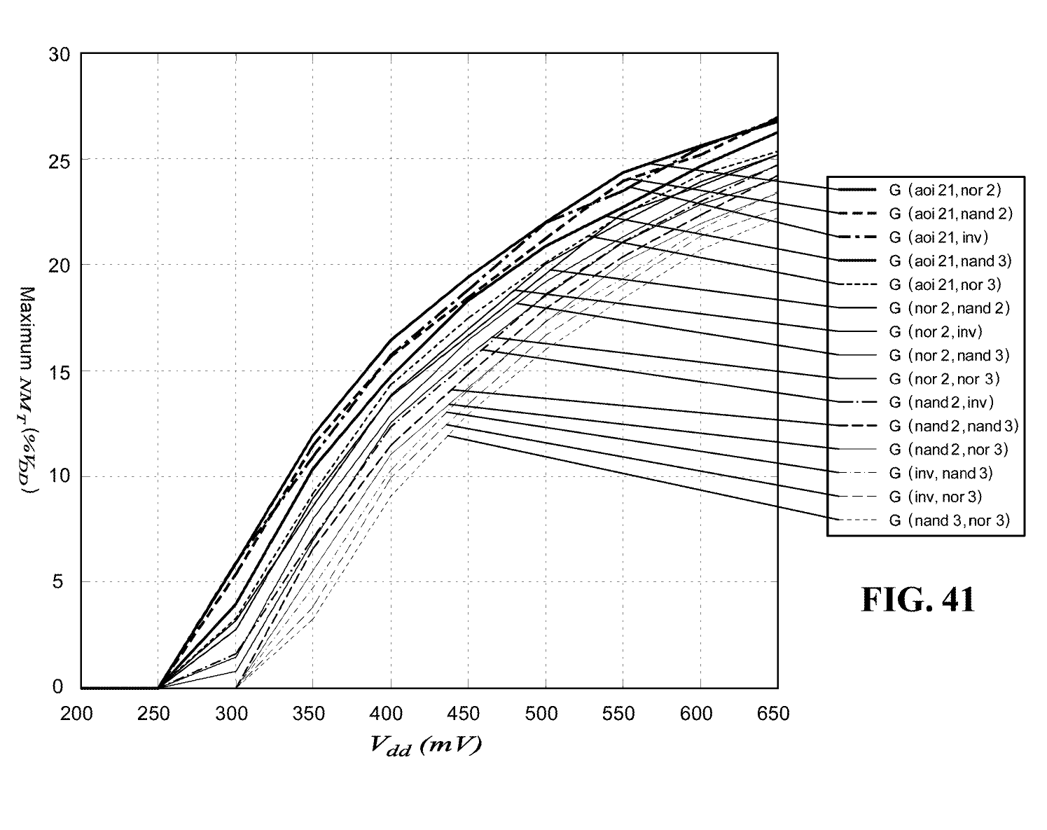

FIG. 40 illustrates an example graph of maximum number of equivalent gate pairs versus V_{DD} for chains of alternating gates and combinations from a defined set of gates for determination of electronic circuit robustness in accordance with one or more embodiments described herein. FIG. 41 illustrates an example graph of maximum noise margin threshold versus V_{DD} for chains of alternating gates and combinations from a defined set of gates for determination of electronic circuit robustness in accordance with one or more embodiments described herein.

Specifically, FIG. 40 illustrates an example maximum number of equivalent gate-pairs vs. V_{DD} with NM_{T}=20% V_{DD} and yield=95% in a commercial 40 nm low-power CMOS process (25° C., TT-Corner). Chains may include alternating gates, and all combinations from the set (INV, NAND2, NOR2, AOI21, NAND3, NOR3) may be considered. The gate choice may have only a small impact on how large of circuit can be constructed, and the most important constraint may be supply voltage; e.g., the maximum circuit size is exponential in V_{DD}.

FIG. 41 illustrates an example maximum NM_{T} vs. V_{DD} for 1M equivalent gate-pairs and yield=95% in a commercial 40 nm low-power CMOS process (25° C., TT-Corner). Chains include alternating gates, and all combinations from the set (INV, NAND2, NOR2, AOI21, NAND3, NOR3) may be considered. Specifically, FIG. 41 may plot the maximum NM_{T} that can be guaranteed (for 1M equivalent gate-pairs in chains and a yield of 95%) versus V_{DD}.

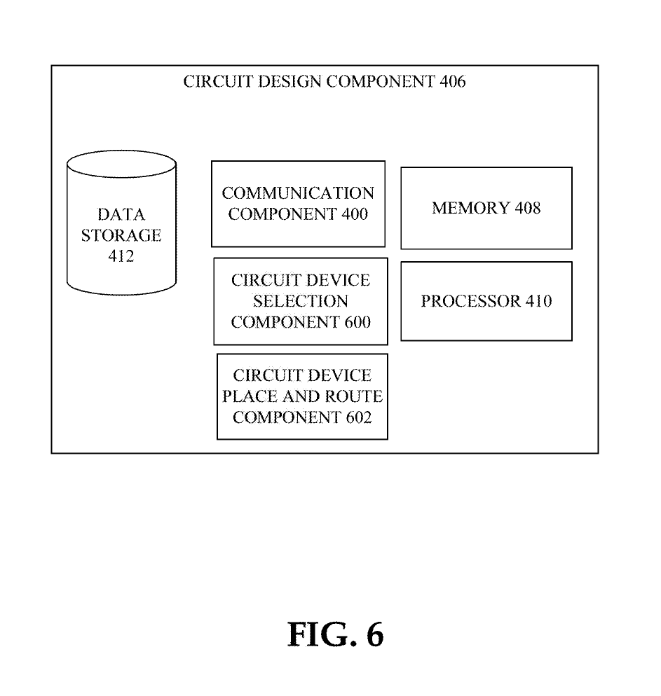

FIG. 6 illustrates an example block diagram of a circuit design component of the device of FIG. 4 and configured to generate information for circuit design based on determination of electronic circuit robustness in accordance with one or more embodiments described herein. Circuit design component 406 can include communication component 400, circuit device selection component 600, circuit device place and route component 602, memory 408, processor 410 and/or data store 412. In various embodiments, one or more of communication component 400, circuit device selection component 600, circuit device place and route component 602, memory 408, processor 410 and/or data store 412 can be electrically and/or communicatively coupled to one another to perform one or more operations of circuit design component 406.

As noted above, in some embodiments, circuit design component 406 can determine a number of gates that can satisfy defined constraints for a circuit. For example, circuit device selection component 600 can select a number of gates and/or types of gates that satisfy the constraint. Circuit device place and route component 602 can determine the arrangement of the selected gates relative to one another to meet the defined constraint.

In some embodiments, circuit design component 406 can generate information that can be employed to identify one or more cell devices and/or place/route for connection of the one or more cell devices. The information can be determined based on a desired performance of the generated circuit and information indicative of the robustness of one or more of the cell devices of the circuit.

Turning back to FIG. 4, memory 408 can be a non-transitory computer-readable storage medium storing computer-executable instructions and/or information for performing the operations described herein with reference to device 102 (or any component of device 102). For example, memory 408 can store computer-executable instructions that can be executed by processor 410 to perform communication, quantification of robustness, generation of information for selection of gates/route/placement and/or prediction of yield information or other types of operations executed by device 102.

Processor 410 can perform or cause to be performed one or more of the operations described herein with reference to device 102 (or any component of device 102). For example, processor 410 can evaluate parameter variation and/or noise for a cell device and/or perform analysis to determine robustness of the cell device in view of parameter variation and noise. As another example, processor 410 can determine robustness of a circuit composed of one or more cell devices. As another example, processor 410 can predict the yield of a circuit composed of one or more cell devices. As another example, processor 410 can generate information indicative of components and place/route for a design of a circuit based on the robustness information determined by processor 410.

Data storage 412 can store various information for use in the methods performed by device 102 including, but not limited to, statistical noise margin, noise margin threshold, probability of pass, probability of failure and/or VTCs for one or more cell devices or circuits and/or computer-executable instructions that can be executed to perform one or more methods dictated by the equations described herein.

FIGS. 7-10 illustrate example flowcharts of methods associated with determination of electronic circuit robustness in accordance with one or more embodiments described herein. An example method may include one or more operations, actions, or functions as illustrated by one or more of blocks shown in FIGS. 7-10. Although illustrated as discrete blocks, various blocks may be divided into additional blocks, combined into fewer blocks, or eliminated, depending on the particular implementation. Blocks may be supplemented with additional blocks representing other operations, actions, or functions. Turning first to FIG. 7, at block 702, method 700 can include storing cell device information at a data store (e.g., using communication component 400).

At block 704, method 700 can include computing one or more statistical VTCs for a cell device represented by the cell device information (e.g., using statistical analysis/characteristic determination component 500 of robustness determination component 402).

At block 706, method 700 can include accessing statistical noise margin data store for the cell device (e.g., using communication component 400). At block 708, method 700 can include accessing circuit diagram information (e.g., using communication component 400).

At block 710, method 700 can include composing one or more statistical VTCs for one or more cell devices represented by the circuit diagram information (e.g., using statistical analysis/characteristic determination component 500 of robustness determination component 402). At block 712, method 700 can include generating information indicative of robustness of the circuit (e.g., using quantification component 502).

Turning now to FIG. 8, at block 802, method 800 can include performing, for a cell device by a unit comprising a processor, statistical analysis to obtain statistical information for the cell device that is indicative of a robustness of the cell device, wherein the robustness of the cell device pertains to a parameter variation of the cell device that is related to a noise of the cell device (e.g., using statistical analysis/characteristic determination component 500 of robustness determination component 402).

At block 804, method 800 can include determining a characteristic of the cell device based on the statistical information (e.g., using statistical analysis/characteristic determination component 500 of robustness determination component 402).

At block 806, method 800 can include associating the characteristic of the cell device with statistical noise margin information for the cell device (e.g., using communication component 400).

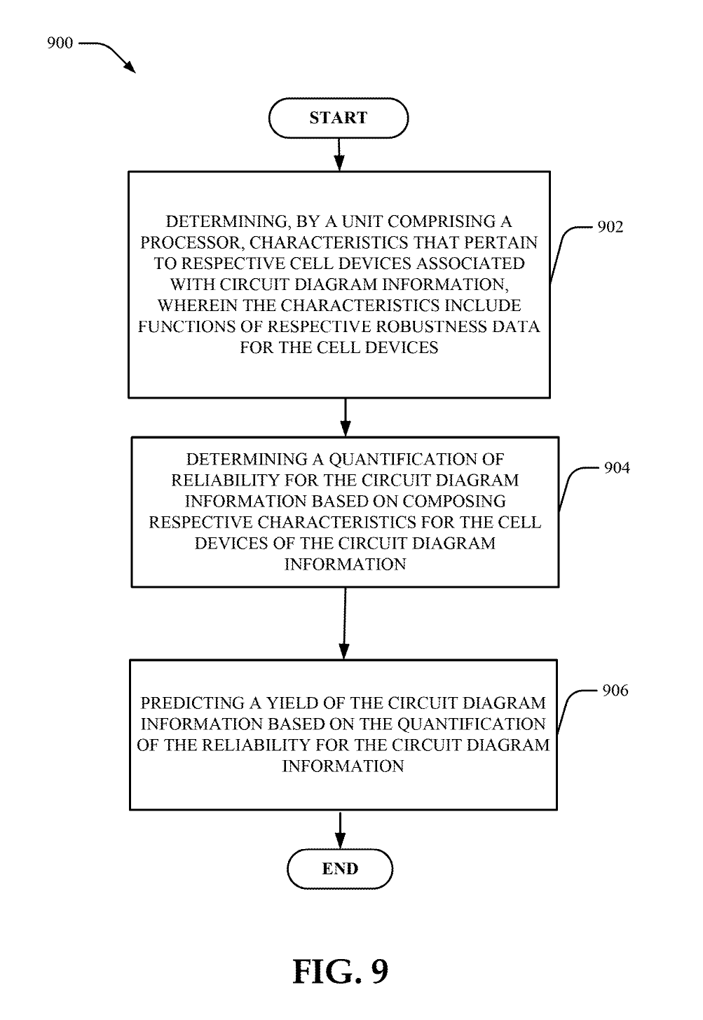

Turning now to FIG. 9, at block 902, method 900 can include determining, by a unit comprising a processor, one or more characteristics that pertain to respective cell devices associated with a circuit design, wherein the characteristics include functions of respective robustness data for the cell devices (e.g., using statistical analysis/characteristic determination component 500 of robustness determination component 402).

At block 904, method 900 can include determining a quantification of reliability for the circuit based on composing respective characteristics for the cell devices of the circuit (e.g., using quantification component 502). At block 906, method 900 can include predicting a yield of the circuit based on the quantification of the reliability for the circuit (e.g., using prediction component 404).

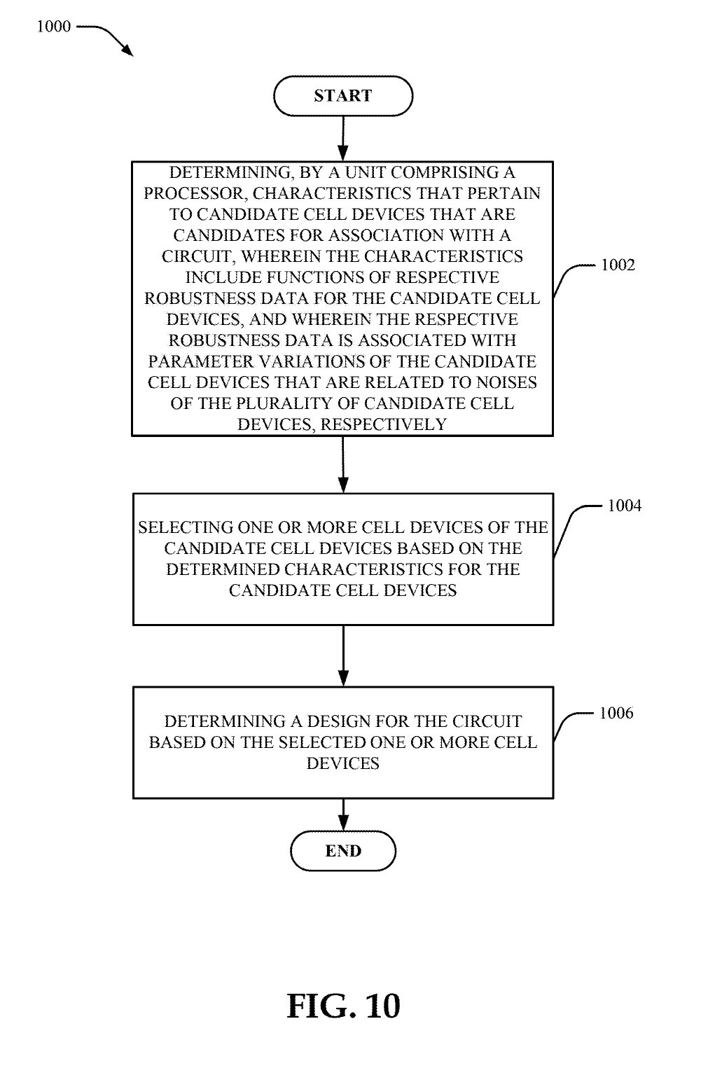

Turning now to FIG. 10, at block 1002, method 1000 can include determining, by a unit comprising a processor, characteristics that pertain to candidate cell devices that are candidates for association with a circuit, wherein the characteristics include functions of respective robustness data for the candidate cell devices, and wherein the respective robustness data is associated with parameter variations of the candidate cell devices that are related to noises of the plurality of candidate cell devices, respectively (e.g., using statistical analysis/characteristic determination component 500 of robustness determination component 402).

At block 1004, method 1000 can include selecting one or more cell devices of the candidate cell devices based on the determined characteristics for the candidate cell devices (e.g., using circuit design component 406). At block 1006, method 1000 can include determining a design for the circuit based on the selected one or more cell devices (e.g., using circuit design component 406).

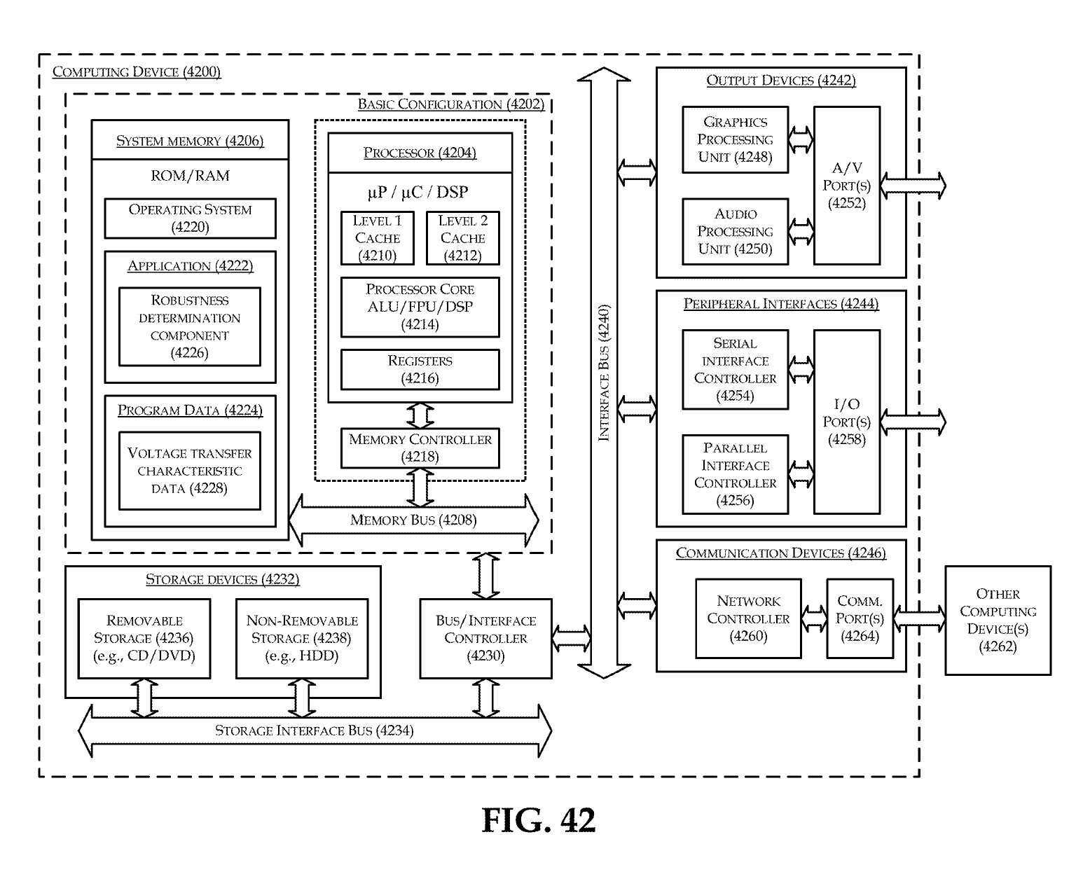

FIG. 42 is a block diagram illustrating an example computing device 4200 that is arranged for determination of circuit robustness in accordance with the present disclosure. In a very basic configuration 4202, computing device 4200 typically includes one or more processors 4204 and a system memory 4206. A memory bus 4208 can be used for communicating between processor 4204 and system memory 4206.

Depending on the desired configuration, processor 4204 can be of any type including but not limited to a microprocessor (μP), a microcontroller (μC), a digital signal processor (DSP), or any combination thereof. Processor 4204 can include one more levels of caching, such as a level one cache 4210 and a level two cache 4212, a processor core 4214, and registers 4216. An example processor core 4214 can include an arithmetic logic unit (ALU), a floating point unit (FPU), a digital signal processing (DSP) core, or any combination thereof. An example memory controller 4218 can also be used with processor 4204, or in some implementations memory controller 4218 can be an internal part of processor 4204.

Depending on the desired configuration, system memory 4206 can be of any type including but not limited to volatile memory (such as RAM), non-volatile memory (such as ROM, flash memory, etc.) or any combination thereof. System memory 4206 can include an operating system 4220, one or more applications 4222, and program data 4224. Application 4222 can include a robustness determination component 4226 that is arranged to determine statistical information about one or more VTCs for a cell device, and determine robustness for a circuit composed of one or more of the cell devices for which the VTCs are determined. In some embodiments, computing device 4200 can be or be included in device 102. Program data 4224 can include, for example, voltage transfer characteristic data 4228 that can be useful for quantification of robustness of a circuit as is described herein. In some embodiments, application 4222 can be arranged to operate with program data 4224 on operating system 4220 such that generation of circuit robustness information, prediction of yields and/or circuit design can be performed as described herein. This described basic configuration 4202 is illustrated in FIG. 42 by those components within the inner dashed line.

Computing device 4200 can have additional features or functionality, and additional interfaces to facilitate communications between basic configuration 4202 and any required devices and interfaces. For example, a bus/interface controller 4230 can be used to facilitate communications between basic configuration 4202 and one or more data storage devices 4232 via a storage interface bus 4234. Data storage devices 4232 can be removable storage devices 4236, non-removable storage devices 4238, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media can include volatile and nonvolatile, removable and non-removable media implemented in any method or technology for storage of information, such as computer readable instructions, data structures, program modules, or other data.

System memory 4206, removable storage devices 4236 and non-removable storage devices 4238 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by computing device 4200. Any such computer storage media can be part of computing device 4200.

Computing device 4200 can also include an interface bus 4240 for facilitating communication from various interface devices (e.g., output devices 4242, peripheral interfaces 4244, and communication devices 4246) to basic configuration 4202 via bus/interface controller 4230. Example output devices 4242 include a graphics processing unit 4248 and an audio processing unit 4250, which can be configured to communicate to various external devices such as a display or speakers via one or more A/V ports 4252. Example peripheral interfaces 4244 include a serial interface controller 4254 or a parallel interface controller 4256, which can be configured to communicate with external devices such as input devices (e.g., keyboard, mouse, pen, voice input device, touch input device, etc.) or other peripheral devices (e.g., printer, scanner, etc.) via one or more I/O ports 4258. An example communication device 4246 includes a network controller 4260, which can be arranged to facilitate communications with one or more other computing devices 4262 over a network communication link via one or more communication ports 4264.

Computing device 4200 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 4200 can also be implemented as a personal computer including both laptop computer and non-laptop computer configurations.

A network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

The use of hardware or software may be generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; if flexibility is paramount, the implementer can opt for a mainly software implementation; or, yet again alternatively, the implementer can opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system can be implemented utilizing any suitable commercially available components, such as those typically found in data computing/communication and/or network computing/communication systems.

The herein described subject matter sometimes illustrates different components contained within, or connected with, different other components. Such depicted architectures are merely examples, and many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably coupleable”, to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The present disclosure is not to be limited in terms of the particular embodiments described in this application, which are intended as illustrations of various aspects. Many modifications and variations can be made without departing from its spirit and scope. Functionally equivalent methods and devices within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. This disclosure is not limited to particular methods, computer-readable storage devices, systems or apparatus disclosed, which can, of course, vary. The terminology used herein is for the purpose of describing particular embodiments only, and is not intended to be limiting.

1. A method, comprising:
performing, for a cell device by a unit comprising a processor, statistical analysis to obtain statistical information for the cell device that is indicative of a robustness of the cell device, wherein the robustness of the cell device pertains to a parameter variation of the cell device that is related to a noise of the cell device;
determining a characteristic of the cell device based on the statistical information; and
associating the characteristic of the cell device with statistical noise margin information for the cell device, wherein the associating comprises storing the characteristic in a data store that stores statistical noise margin information for the cell device.

2. The method of claim 1, wherein determining the characteristic comprises determining a voltage transfer characteristic of the cell device.

3. The method of claim 1, wherein the parameter variation of the cell device comprises at least one of a channel length variation, an oxide thickness variation, or a dopant concentration variation of a component of the cell device, relative to another cell device.

4-5. (canceled)

6. The method of claim 1, wherein determining the characteristic of the cell device comprises determining the characteristic for a cell device that includes at least one of an inverter, a memory device, a transistor, a logic gate, or a register.

7. A method, comprising:
determining, by a unit comprising a processor, characteristics that pertain to respective cell devices associated with circuit diagram information, wherein the characteristics include functions of respective robustness data for the cell devices;
determining a quantification of reliability for the circuit diagram information based on composing respective characteristics for the cell devices of the circuit diagram information; and
associating the respective characteristics for the cell devices with statistical noise margin information for the cell devices, wherein the associating comprises storing the respective characteristics in a data store that aggregates statistical noise margin information for the cell devices.

8. The method of claim 7, wherein the respective robustness data represents respective functions of parameter variations of the respective cell devices.

9. The method of claim 7, further comprising:
obtaining information indicative of a description of the cell devices from the circuit diagram information.

10. The method of claim 7, further comprising:
predicting a yield of the circuit diagram information based on the quantification of the reliability for the circuit diagram information.

11. A method, comprising:
determining, by a unit comprising a processor, characteristics that pertain to candidate cell devices that are candidates for association with a circuit, wherein the characteristics include functions of respective robustness data for the candidate cell devices, wherein the respective robustness data is associated with parameter variations of the candidate cell devices that are related to noises of the plurality of candidate cell devices, respectively, and wherein the parameter variations of the candidate cell devices comprise at least one of an oxide thickness variation or a dopant concentration variation of a component of the candidate cell devices;
selecting one or more cell devices of the candidate cell devices based on the determined characteristics that pertain to the candidate cell devices; and
determining a design for the circuit based on the selected one or more cell devices.

12. The method of claim 11, further comprising:
predicting a yield of the circuit based on the determined characteristics of that pertain to the one or more cell devices.

13. The method of claim 11, further comprising:
obtaining information indicative of a description of the candidate cell devices from circuit diagram information.

14. An apparatus, comprising:
a first component configured to perform statistical analysis for a cell device to determine a robustness of the cell device, wherein the robustness of the cell device is associated with a parameter variation of the cell device that is related to a noise of the cell device;
a second component coupled to the first component and configured to generate statistical information for the cell device based on the statistical analysis, wherein the statistical information is indicative of the robustness of the cell device;
a third component coupled to the second component and configured to determine a characteristic of the cell device based on the statistical information; and
a fourth component coupled to the third component and configured to associate the characteristic of the cell device with statistical noise margin information for the cell device, wherein the association of the characteristic with the statistical noise margin information comprises the characteristic being stored in a data store configured to store the statistical noise margin information for the cell device.

15. The apparatus of claim 14, wherein the characteristic comprises a voltage transfer characteristic of the cell device.

16. The apparatus of claim 14, wherein the parameter variation of the cell device comprises at least one of a channel length variation, an oxide thickness variation, or a dopant concentration variation of a component of the cell device, relative to another cell device.

17. (canceled)

18. A non-transitory computer-readable storage medium including computer-executable instructions stored thereon that, in response to execution by a processor, cause a device to perform operations, comprising:
determining characteristics that pertain to respective cell devices associated with a circuit design, wherein the characteristics include functions of respective robustness data for the cell devices, and wherein the respective robustness data are based on parameter variations of the respective cell devices and noises of the respective cell devices;
determining a quantification of reliability for the circuit design based on composing the respective characteristics for the cell devices of the circuit design; and
associating the respective characteristics of the cell devices with statistical noise margin information for the cell devices, wherein the associating comprises storing the respective characteristics in a data store to enable analysis of the statistical noise margin information for the cell devices.

19. The non-transitory computer-readable storage medium of claim 18, wherein the operations further comprise:
predicting a yield of the circuit design.

20. The non-transitory computer-readable storage medium of claim 18, wherein the characteristics comprise a voltage transfer characteristic of the respective cell devices.

21. The non-transitory computer-readable storage medium of claim 18, wherein the parameter variations comprise variations of channel length for a component of the respective cell devices.

22. (canceled)

23. The non-transitory computer-readable storage medium of claim 18, wherein the parameter variations comprise variations of at least one of oxide thickness or dopant concentration for a component of the respective cell devices.

24. The non-transitory computer-readable storage medium of claim 19, wherein the predicting the yield of the circuit design is based on the quantification of the reliability for the circuit design.

25. The method of claim 8, wherein the respective functions of parameter variations of the respective cell devices are related to respective noises of the respective cell devices.
